(19) United States
(12) Patent Application Publication
(10) Pub. No.: US 2026/0095113 A1
(43) Pub. Date: Apr. 2, 2026

(54) ELECTRIC WORK MACHINE

(71) Applicant: MAKITA CORPORATION, Anjo-shi (JP)

(72) Inventors: Masumi Nishimura, Anjo-shi (JP); Eitetsu Ishikawa, Anjo-shi (JP)

(73) Assignee: MAKITA CORPORATION, Anjo-shi (JP)

(21) Appl. No.: 19/340,236

(22) Filed: Sep. 25, 2025

(30) Foreign Application Priority Data
Sep. 30, 2024 (JP) 2024-171030

(51) Int. Cl. H02P 3/22; A01D 69/02; H02P 23/20; H02P 25/03

(52) U.S. Cl. CPC H02P 3/22; H02P 23/20; H02P 25/03; A01D 69/02

(57) ABSTRACT

One aspect of the present disclosure provides an electric work machine including a brushless motor, a drive circuit, and a control circuit. The control circuit executes a driving operation, a braking operation, and a switching operation. In the driving operation, the brushless motor is rotated based on a back-EMF of the brushless motor. In the braking operation, a switch pair of six switches in the drive circuit is turned on, and the other four switches are turned off. The switching operation is performed during the braking operation. The switching operation includes switching the switch pair. In the switching operation, an off-target switch is turned off based on an electric current flowing through the off-target switch satisfying an off-requirement.

### CROSS-REFERENCE TO RELATED APPLICATIONS

The present application claims the benefit of Japanese Patent Application No. 2024-171030 filed with the Japanese Patent Office on Sep. 30, 2024, and the entire disclosure of which is incorporated herein by reference.

### BACKGROUND

The present disclosure relates to a technique for braking a brushless motor in an electric work machine.

Japanese Unexamined Patent Application Publication No. 2013-243824 discloses a technique for braking a brushless motor using two-phase short-circuit control (that is, two-phase dynamic braking). In two-phase short-circuit control, two switches in a switching circuit (hereinafter referred to as a “switch pair”) are turned on. The switch pair is two of three high-side switches or two of three low-side switches. The combination of the two switches constituting the switch pair is sequentially switched according to the rotation of the brushless motor.

### SUMMARY

In two-phase short-circuit control, when the switch pair is switched, one of the two switches that are on (hereinafter referred to as an “off-target switch”) is turned off. If the timing of turning off the off-target switch is not appropriate, the switching circuit may be affected. Thus, the off-target switch is desirably turned off at an appropriate timing.

If the brushless motor includes a sensing device such as a Hall sensor, the rotational position can be appropriately detected even during execution of two-phase dynamic braking. In this case, the off-target switch can be turned off at an appropriate timing.

On the other hand, a so-called sensorless method is known, in which the rotational position of a brushless motor is detected based on a back-EMF of the brushless motor, without using a sensing device. Even in such a sensorless system, it is desirable that two-phase dynamic braking can be appropriately executed.

In one aspect of the present disclosure, it is desirable that a brushless motor of an electric work machine can be appropriately braked by two-phase dynamic braking without using a sensing device for detecting a rotational position.

In the present disclosure, the terms “first”, “second”, and the like are merely intended to distinguish elements from one another, but not to limit the order or number of elements. Therefore, a first element may be referred to as a second element, and similarly, the second element may be referred to as the first element. In addition, the first element may be provided without the second element, or similarly, the second element may be provided without the first element.

One aspect of the present disclosure provides an electric work machine including a brushless motor, a drive circuit, and a control circuit.
The brushless motor includes three terminals configured to receive an electric power.

The drive circuit supplies the electric power to the brushless motor. The drive circuit includes three positive-electrode-side paths, three negative-electrode-side paths, and six switches. The three positive-electrode-side paths respectively electrically couple the three terminals to a positive electrode of a power source. The three negative-electrode-side paths respectively electrically couple the three terminals to a negative electrode of the power source.

The six switches include three positive-electrode-side switches and three negative-electrode-side switches. The three positive-electrode-side switches (i) are provided on the three positive-electrode-side paths, respectively, and (ii) individually complete or interrupt the three positive-electrode-side paths. The three negative-electrode-side switches (i) are provided on the three negative-electrode-side paths, respectively, and (ii) individually complete or interrupt the three negative-electrode-side paths.

The control circuit executes a driving operation, a braking operation, and a switching operation.
The driving operation is an operation of controlling the drive circuit, based on a back-EMF of the brushless motor generated at each of the three terminals, to rotate the brushless motor.

The braking operation is an operation for decelerating and/or stopping the brushless motor during rotation of the brushless motor. The braking operation includes turning on a switch pair of the six switches and turning off the other switches of the six switches. The switch pair is two of the three positive-electrode-side switches or two of the three negative-electrode-side switches.

The switching operation is an operation of switching the switch pair during execution of the braking operation. The switching operation includes turning off an off-target switch based on an electric current flowing through the off-target switch satisfying an off-requirement. The off-target switch is one of the switches in the switch pair at the present time.

In the electric work machine configured as described above, in the switching operation, the off-target switch is turned off based on the electric current flowing through the off-target switch satisfying the off-requirement. Thus, the brushless motor can be appropriately braked by two-phase dynamic braking without using a sensing device for detecting a rotational position (i.e., in a sensorless manner).

### BRIEF DESCRIPTION OF THE DRAWINGS

Example embodiments of the present disclosure will be described hereinafter with reference to the accompanying drawings, in which:

FIG. 1 is a perspective view of an electric work machine according to a first embodiment;

FIG. 2 is an explanatory diagram showing an electrical configuration of the electric work machine according to the first embodiment;

FIG. 3 is an explanatory diagram showing an operation example of a motor at the time of execution of free running;

FIG. 4 is an explanatory diagram showing an operation example of a motor when three-phase dynamic braking is executed;

FIG. 5 is an explanatory diagram showing a switch pair table;

FIG. 6 is an explanatory diagram showing an operation example of two-phase dynamic braking;

FIG. 7 is an explanatory diagram showing an operation example during a transition from the driving operation to two-phase dynamic braking;

FIG. 8 is a flowchart of the main process according to the first embodiment;

FIG. 9 is a flowchart of a motor control process according to the first embodiment;

FIG. 10 is a flowchart of a soft braking start process according to the first embodiment;

FIG. 11 is a flowchart of a comparator interrupt process according to the first embodiment;

FIG. 12 is a flowchart of a commutation timer interrupt process according to the first embodiment;

FIG. 13 is a flowchart of a motor control process according to a second embodiment;

FIG. 14 is an explanatory diagram showing an operation example of two-phase dynamic braking according to the second embodiment;

FIG. 15 is an explanatory diagram showing an operation example of a motor according to a third embodiment;

FIG. 16 is an explanatory diagram showing a one-phase pattern table;

FIG. 17 is a flowchart of a motor control process according to the third embodiment;

FIG. 18 is a flowchart of a comparator interrupt process according to the third embodiment;

FIG. 19 is a flowchart of a commutation timer interrupt process according to the third embodiment;

FIG. 20 shows an operation example of the motor when no measure is taken against a timer interrupt delay;

FIG. 21 shows an operation example of a motor according to a fourth embodiment in which a measure is taken against a timer interrupt delay;

FIG. 22 is a flowchart of a comparator interrupt process according to the fourth embodiment;

FIG. 23 is a flowchart of a commutation timer interrupt process according to the fourth embodiment;

FIG. 24 is an explanatory diagram showing a switch pair table according to a fifth embodiment;

FIG. 25 is an explanatory diagram showing an operation example of two-phase dynamic braking according to the fifth embodiment;

FIG. 26 is an explanatory diagram showing a switch pair table according to a sixth embodiment; and

FIG. 27 is an explanatory diagram showing an operation example of two-phase dynamic braking according to the sixth embodiment.

### DETAILED DESCRIPTION OF EXEMPLARY EMBODIMENTS

### 1. Overview of Embodiments

One embodiment may provide an electric work machine including at least any one of the following features:
Feature 1: a brushless motor (or a brushless DC motor);
Feature 2: the brushless motor includes three terminals, the three terminals are configured to receive an electric power;
Feature 3: a drive circuit;
Feature 4: the drive circuit is configured to supply (or deliver) the electric power to the brushless motor (that is, to the three terminals);
Feature 5: the drive circuit includes three positive-electrode-side paths;
Feature 6: the three positive-electrode-side paths electrically couple (or connect) the three terminals, respectively, to a positive electrode of a power source;
Feature 7: the drive circuit includes three negative-electrode-side paths;
Feature 8: the three negative-electrode-side paths electrically couple (or connect) the three terminals, respectively, to a negative electrode of the power source;
Feature 9: the drive circuit includes six switches;
Feature 10: the six switches include three positive-electrode-side switches;
Feature 11: the three positive-electrode-side switches are (i) provided on the three positive-electrode-side paths, respectively, and (ii) configured to individually complete (or conduct, or connect) or interrupt (or cut off, or disconnect) the three positive-electrode-side paths, respectively;
Feature 12: the six switches include three negative-electrode-side switches;
Feature 13: the three negative-electrode-side switches are (i) provided on the three negative-electrode-side paths, respectively, and (ii) configured to individually complete or interrupt the three negative-electrode-side paths, respectively;
Feature 14: a control circuit;
Feature 15: the control circuit is configured to execute a driving operation;
Feature 16: the driving operation includes controlling the drive circuit, based on a back-EMF (or an induced voltage) of the brushless motor generated at each of the three terminals, to thereby rotate the brushless motor;
Feature 17: the control circuit is configured to execute a braking operation. The braking operation may be executed during rotation of the brushless motor;
Feature 18: the braking operation is an operation for decelerating and/or stopping the brushless motor during rotation;
Feature 19: the braking operation includes turning on a switch pair of the six switches and turning off the other switches of the six switches;
Feature 20: the switch pair is two of the three positive-electrode-side switches or two of the three negative-electrode-side switches;
Feature 21: the control circuit is configured to execute a switching operation;
Feature 22: the switching operation is an operation of switching the switch pair during execution of the braking operation, the switching of the switch pair being definable as switching (changing) at least one of two switches corresponding to the switch pair (in other words, included in the switch pair or constituting the switch pair) to another switch;
Feature 23: the switching operation includes turning off an off-target switch;
Feature 24: the off-target switch is one of the switches in the switch pair at the present time, and more specifically, the off-target switch may be one of two switches corresponding to the switch pair at the present time; and
Feature 25: the switching operation includes turning off the off-target switch based on an electric current flowing through the off-target switch satisfying an off-requirement, which may be required to turn off the off-target switch.

In the electric work machine including at least Features 1 through 25, in the switching operation, the off-target switch is turned off based on the electric current flowing through the off-target switch satisfying the off-requirement. Thus, the brushless motor can be appropriately braked by two-phase dynamic braking (or two-phase short-circuit control) without using a sensing device for detecting a rotational position.

The brushless motor may be configured to be driven by receiving three-phase power. The brushless motor may include three coils that are delta-connected to each other. The brushless motor may include three coils that are star-connected to each other. The three coils may be electrically connected to the three terminals. The three coils may be configured to receive the electric power from the three terminals. The term “back-EMF” is an abbreviation of “back electromotive force.” The term “back-EMF” may also be referred to as “counter EMF” or “induced voltage.”

The power source may include a battery. The battery may be configured to be repeatedly chargeable. The electric work machine may be configured such that the battery pack including the battery is detachably attached.

One embodiment may include at least any one of the following features in addition to or in place of at least any one of Features 1 through 25 described above:
Feature 26: the off-requirement is satisfied based on the electric current flowing through the off-target switch avoiding a specific state;
Feature 27: the specific state includes (i) that the electric current is flowing in a direction opposite to the specific direction and (ii) that the magnitude of the electric current corresponds to an extreme value; and
Feature 28: (i) when the off-target switch is one of the three positive-electrode-side switches, the specific direction is a direction from the brushless motor toward the positive electrode via the off-target switch, and/or (ii) when the off-target switch is one of the three negative-electrode-side switches, the specific direction is a direction from the negative electrode toward the brushless motor via the off-target switch.

In the electric work machine including at least Features 1 through 28, it is possible to suppress a regenerative current flowing from the motor to the power source in response to the off-target switch being turned off.
One embodiment may include the following feature in addition to or in place of at least any one of Features 1 through 28 described above:
Feature 29: the off-requirement is satisfied based on the electric current flowing in the specific direction at the off-target switch.

In the electric work machine including at least Features 1 through 25 and 29, it is possible to further suppress a regenerative current flowing from the motor to the power source in response to the off-target switch being turned off.

One embodiment may include at least any one of the following features in addition to or in place of at least any one of Features 1 through 29 described above:
Feature 30: a current information acquisition circuit;
Feature 31: the current information acquisition circuit is configured to acquire current information;
Feature 32: the current information is information on an electric current flowing through each of two or more specific switches, which may be two or more of the six switches that can be the switch pair in the braking operation; and
Feature 33: the control circuit is configured to execute the switching operation based on the current information acquired by the current information acquisition circuit.

The current information may include information directly or indirectly indicating a direction of the electric current flowing through each of the two or more specific switches.
The three terminals may include a first terminal, a second terminal, and a third terminal. The current information may include a first voltage, a second voltage, and/or a third voltage.

The first voltage is a voltage of the first terminal. When an electric current flows through the switch connected to the first terminal, the first voltage may change according to the magnitude and/or direction of the electric current. Thus, the magnitude and/or direction of the electric current flowing through the switch connected to the first terminal can be detected (or estimated) based on the first voltage.

The second voltage is a voltage of the second terminal. When an electric current flows through the switch connected to the second terminal, the second voltage may change according to the magnitude and/or direction of the electric current. Thus, the magnitude and/or direction of the electric current flowing through the switch connected to the second terminal can be detected (or estimated) based on the second voltage.

The third voltage is a voltage of the third terminal. When an electric current flows through the switch connected to the third terminal, the third voltage may change according to the magnitude and/or direction of the electric current. Thus, the magnitude and/or direction of the electric current flowing through the switch connected to the third terminal can be detected (or estimated) based on the third voltage.

Therefore, in the electric work machine including at least Features 1 to 25 and 30 to 33, the off-target switch can be turned off at an appropriate timing.

One embodiment may include at least any one of the following features in addition to or in place of at least any one of Features 1 through 33 described above:
Feature 34: the current information acquisition circuit includes a first comparator;
Feature 35: the first comparator is configured to receive the first voltage and the reference voltage;
Feature 36: the first comparator is configured to output first comparison information;
Feature 37: the first comparison information indicates whether a value of the first voltage is greater than or equal to a value of the reference voltage;
Feature 38: the current information acquisition circuit includes a second comparator;
Feature 39: the second comparator is configured to receive the second voltage and the reference voltage;
Feature 40: the second comparator is configured to output second comparison information;
Feature 41: the second comparison information indicates whether a value of the second voltage is greater than or equal to the value of the reference voltage;
Feature 42: the current information acquisition circuit includes a third comparator;
Feature 43: the third comparator is configured to receive the third voltage and the reference voltage;
Feature 44: the third comparator is configured to output third comparison information; and
Feature 45: the third comparison information indicates whether a value of the third voltage is greater than or equal to the value of the reference voltage.

In the electric work machine including at least Features 1 through 25 and 30 through 45, the off-target switch can be turned off at an appropriate timing.
One embodiment may include the following feature in addition to or in place of at least any one of Features 1 through 45 described above:
Feature 46: the control circuit is configured to execute the driving operation based on the first comparison information, the second comparison information, and the third comparison information output from the current information acquisition circuit.

In the electric work machine including at least Features 1 through 25 and 30 through 46, the first, second, and third comparison information is used in both the driving operation and the braking operation. Thus, an efficient configuration of the electric work machine is implemented.

One embodiment may include the following feature in addition to or in place of at least any one of Features 1 through 46 described above:
Feature 47: the off-requirement is satisfied based on a change in the first comparison information, the second comparison information, and/or the third comparison information.

In the electric work machine including at least Features 1 through 25, 30 through 45, and 47, the timing to turn off the off-target switch can be easily determined with a simple configuration.
One embodiment may include the following feature in addition to or in place of at least any one of Features 1 through 47 described above:
Feature 48: in a state where the braking operation, in which two of the three negative-electrode-side switches are set as the switch pair, is being executed, the off-requirement is satisfied based on a value of a voltage of a first specific terminal becoming smaller than the value of the reference voltage, the first specific terminal is one of the three terminals that is electrically coupled (or connected) to the off-target switch.

The fact that the value of the voltage of the first specific terminal is smaller than the value of the reference voltage indicates that an electric current in the specific direction is (or may be) flowing through the off-target switch. When the value of the voltage of the first specific terminal becomes smaller than the value of the reference voltage, the comparison information corresponding to the first specific terminal may change. Thus, an appropriate off-timing of the off-target switch can be determined based on at least one change in the first, second, and third comparison information.

Therefore, in the electric work machine including at least Features 1 through 25, 30 through 45, and 48, the timing to turn off the off-target switch can be easily determined with a simple configuration.
One embodiment may include at least any one of the following features in addition to or in place of at least any one of Features 1 through 48 described above:
Feature 49: in a state where the braking operation, in which two of the three negative-electrode-side switches are set as the switch pair, is being executed, the off-requirement is satisfied based on arrival of an off-available timing; and
Feature 50: the off-available timing is a timing at which (i) the value of the voltage of the first specific terminal becomes smaller than the value of the reference voltage, and (ii) a value of a voltage of a second specific terminal becomes greater than or equal to the value of the reference voltage, the second specific terminal is (i) one of the three terminals and (ii) electrically coupled (or connected) to one of the three negative-electrode-side switches other than the switch pair.

In the electric work machine including at least Features 1 through 25, 30 through 45, and 48 through 50, the timing to turn off the off-target switch can be easily determined with a simple configuration.
One embodiment may include the following feature in addition to or in place of at least any one of Features 1 through 50 described above:
Feature 51: in a state where the braking operation, in which two of the three negative-electrode-side switches are set as the switch pair, is being executed, the off-requirement is satisfied based on elapse of a delay time from the off-available timing, the delay time being determinable in any manner and determinable in advance.

The magnitude of the electric current flowing through the off-target switch in the specific direction can be reduced or zero when a certain time elapses from the off-available timing.
Thus, in the electric work machine including at least Features 1 through 25, 30 through 45, and 48 through 51, the off-target switch can be turned off in a state where the electric current flowing through the off-target switch has been reduced.

One embodiment may include the following feature in addition to or in place of at least any one of Features 1 through 51 described above:
Feature 52: the control circuit is configured to set the delay time such that the off-requirement is satisfied when the magnitude of the electric current flowing through the off-target switch tends to decrease or is zero.

In the electric work machine including at least Features 1 through 25, 30 through 45, and 48 through 52, the off-target switch can be turned off in a state where the electric current flowing through the off-target switch is reduced or zero.

One embodiment may include the following feature in addition to or in place of at least any one of Features 1 through 52 described above:
Feature 53: the control circuit is configured to set, in response to arrival of the off-available timing, the delay time based on a rotational speed of the brushless motor at the arrival of the off-available timing.

In the electric work machine including at least Features 1 through 25, 30 through 45, 48 through 51, and 53, it is possible to set the appropriate delay time corresponding to the rotational speed. The rotational speed may be the number of rotations per unit time (e.g., one minute or one second). The rotational speed may also be referred to as the number of rotations or an angular velocity.

One embodiment may include the following feature in addition to or in place of at least any one of Features 1 through 53 described above:
Feature 54: the control circuit is configured to set the delay time such that the lower the rotational speed of the brushless motor at the arrival of the off-available timing, the longer the delay time.

In the electric work machine including at least Features 1 through 25, 30 through 45, 48 through 51, 53, and 54, it is possible to set the appropriate delay time corresponding to the rotational speed.

One embodiment may include at least any one of the following features in addition to or in place of at least any one of Features 1 through 54 described above;
Feature 55: a reference voltage generation circuit;
Feature 56: the reference voltage generation circuit includes a first resistor;
Feature 57: the first resistor has (i) a first end electrically coupled (or connected) to the first terminal and (ii) a second end;
Feature 58: the reference voltage generation circuit includes a second resistor;
Feature 59: the second resistor has (i) a first end electrically coupled (or connected) to the second terminal and (ii) a second end electrically coupled (or connected) to the second end of the first resistor;
Feature 60: the reference voltage generation circuit includes a third resistor;
Feature 61: the third resistor has (i) a first end electrically coupled (or connected) to the third terminal, and (ii) a second end electrically coupled (or connected) to the second end of the first resistor and the second end of the second resistor;
Feature 62: the reference voltage generation circuit is configured to output a first reference voltage;
Feature 63: the first reference voltage is a voltage of the second end of the first resistor, a voltage of the second end of the second resistor, or a voltage of the second end of the third resistor; and
Feature 64: the current information acquisition circuit is configured to receive the first reference voltage as the reference voltage from the reference voltage generation circuit.

In the electric work machine including at least Features 1 through 25, 30 through 45, and 55 through 64, it is possible to easily generate the reference voltage that is appropriate.

One embodiment may include the following feature in addition to or in place of at least any one of Features 1 through 64 described above:
Feature 65: the current information acquisition circuit is configured to receive a negative-electrode-side voltage as the reference voltage in a state where the braking operation, in which two of the three negative-electrode-side switches form the switch pair, is being executed, each of the three negative-electrode-side switches may include a negative-electrode-side terminal electrically coupled (or connected) to the negative electrode. The negative-electrode-side voltage may be a voltage of the negative-electrode-side terminal of one of the three negative-electrode-side switches.

In the electric work machine including at least Features 1 through 25, 30 through 45, and 65, an appropriate reference voltage can be easily generated.
One embodiment may include the following feature in addition to or in place of at least any one of Features 1 through 65 described above:
Feature 66: the current information acquisition circuit is configured to receive a positive-electrode-side voltage as the reference voltage in a state where the braking operation, in which two of the three positive-electrode-side switches form the switch pair, is being executed. Each of the three positive-electrode-side switches may include a positive-electrode-side terminal electrically coupled (or connected) to the positive electrode. The positive-electrode-side voltage may be a voltage of the positive-electrode-side terminal of one of the three positive-electrode-side switches.

In the electric work machine including at least Features 1 through 25, 30 through 45, and 66, it is possible to easily generate the reference voltage that is appropriate.

One embodiment may include at least any one of the following features in addition to or in place of at least any one of Features 1 through 66 described above:
Feature 67: a selection circuit;
Feature 68: the selection circuit is configured to receive at least two reference voltages, the at least two reference voltages being at least two of the first reference voltage, the second reference voltage, and the third reference voltage;
Feature 69: the selection circuit is configured to alternatively output, as the reference voltage, one of the at least two reference voltages that have been received;
Feature 70: the second reference voltage is a voltage of the negative-electrode-side terminal of one of the three negative-electrode-side switches;
Feature 71: the third reference voltage is a voltage of the positive-electrode-side terminal of one of the three positive-electrode-side switches; and
Feature 72: the current information acquisition circuit is configured to receive the reference voltage output from the selection circuit.

In the electric work machine including at least Features 1 through 25, 30 through 45, 55 through 64, and 67 through 72, the reference voltage can be alternatively set.
One embodiment may include at least any one of the following features in addition to or in place of at least any one of Features 1 through 72 described above:
Feature 73: a fourth resistor;
Feature 74: the fourth resistor has (i) a first end electrically coupled (or connected) to the positive electrode and (ii) a second end;
Feature 75: a fifth resistor;
Feature 76: the fifth resistor has (i) a first end electrically coupled (or connected) to the negative electrode and (ii) a second end electrically coupled (or connected) to the second end of the fourth resistor;
Feature 77: a selection circuit;
Feature 78: the selection circuit is configured to receive at least two reference voltages, the at least two reference voltages are at least two of the first reference voltage, the second reference voltage, the third reference voltage, and the fourth reference voltage;
Feature 79: the selection circuit is configured to alternatively output, as the reference voltage, one of the at least two reference voltages that have been received;
Feature 80: the fourth reference voltage is a voltage of the second end of the fourth resistor; and
Feature 81: the current information acquisition circuit is configured to receive the reference voltage output from the selection circuit.

In the electric work machine including at least Features 1 through 25, 30 through 45, 55 through 64, and 73 through 81, the reference voltage can be selected from more options.
One embodiment may include at least one of the following features in addition to or in place of at least any one of Features 1 through 81 described above:
Feature 82: the selection circuit is configured to output the fourth reference voltage as the reference voltage when the driving operation is being performed by the control circuit; and
Feature 83: the selection circuit is configured to output the first reference voltage, the second reference voltage, or the third reference voltage as the reference voltage when the switching operation (and/or the braking operation) is being performed by the control circuit.

In the electric work machine including at least Features 1 through 25, 30 through 45, 55 through 64, and 73 through 83, the reference voltage can be easily acquired from the selection circuit.

One embodiment may include at least any one of the following features in addition to or in place of at least any one of Features 1 through 83 described above:
Feature 84: each of the three positive-electrode-side switches includes a first rectifier;
Feature 85: the first rectifier is connected in parallel with the corresponding positive-electrode-side switch; and
Feature 86: the first rectifier is configured to (i) allow flowing an electric current from the brushless motor to the positive electrode via the first rectifier, and (ii) suppress or prevent flowing an electric current from the positive electrode to the brushless motor via the first rectifier.

In the electric work machine including at least Features 1 through 25 and 84 through 86, it is possible to suppress or prevent the flow of a regenerative current from the brushless motor to the power source via the first rectifier during the switching operation.

One embodiment may include at least any one of the following features in addition to or in place of at least any one of Features 1 through 86 described above:
Feature 87: each of the three negative-electrode-side switches includes a second rectifier;
Feature 88: the second rectifier is connected in parallel with the corresponding negative-electrode-side switch; and
Feature 89: the second rectifier is configured to (i) allow flowing an electric current from the negative electrode to the brushless motor via the second rectifier and (ii) suppress or prevent flowing an electric current from the brushless motor to the negative electrode via the second rectifier.

In the electric work machine including at least Features 1 through 25 and 87 through 89, it is possible to suppress or prevent the flow of a regenerative current from the brushless motor to the power source via the second rectifier during the switching operation.

In one embodiment, at least one of the six switches may be a semiconductor switch or a mechanical relay. Examples of the semiconductor switch include a field-effect transistor (FET), a bipolar transistor, an insulated gate bipolar transistor (IGBT), a thyristor, and a solid-state relay (SSR).

In one embodiment, the control circuit may be integrated into a single electronic unit, a single electronic device, or a single circuit board.
In one embodiment, the control circuit may be a combination of two or more electronic circuits, two or more electronic units, or two or more electronic devices individually provided on or within the electric work machine.

In one embodiment, the control circuit may include a microcomputer (or a microcontroller, or a microprocessor), connection logic, an application-specific integrated circuit (ASIC), an application-specific standard product (ASSP), a programmable logic device (e.g., a field-programmable gate array (FPGA)), discrete electronic components, and/or combinations thereof.

Examples of the electric work machine include various field working machines that are used at work sites such as building construction, manufacturing, civil engineering, general construction, agriculture, horticulture, cleaning, and home carpentry, and are configured to receive electric power to operate brushless motors. The electric work machine may be configured to operate using the electric power of the battery, or may be configured to operate by receiving alternating current (AC) power. More specific examples of the electric work machine include electric tools for masonry, metalworking, and woodworking, working machines for gardening, and equipment that improve the work site environment, and more specifically, an electric blower, an electric hammer, an electric hammer drill, an electric drill, an electric driver, an electric wrench, an electric grinder, an electric circular saw, an electric reciprocating saw, an electric jigsaw, an electric cutter, an electric chain saw, an electric planer, an electric nailing machine (including a riveting machine), an electric hedge trimmer, an electric lawn mower, an electric lawn clipper, an electric brush cutter, an electric cleaner, an electric sprayer, an electric spreader, an electric dust collector, an electric trowel, an electric vibrator, an electric rammer, an electric compactor, an electric pump, an electric pile driver, an electric concrete saw, an electric screed, an electric cut-off saw, a coffee machine (or a coffee maker, or a coffee distiller), a robot cleaner, a battery-powered wheelbarrow, a battery-powered bicycle, and a fan vest.

In one embodiment, Features 1 through 89 described above may be combined in any combination.

In one embodiment, any of Features 1 through 89 described above may be excluded.

### 2. Specific Exemplary Embodiments

Hereinafter, descriptions will be given of first to sixth embodiments as specific exemplary embodiments.

### 2-1. First Embodiment

A first embodiment provides an electric work machine 1 in the form of an electric brush cutter (or an electric grass trimmer). However, such an electric work machine 1 is merely an example, and the present disclosure can be applied to any form of electric work machine.

### (2-1-1) Configuration of Electric Work Machine

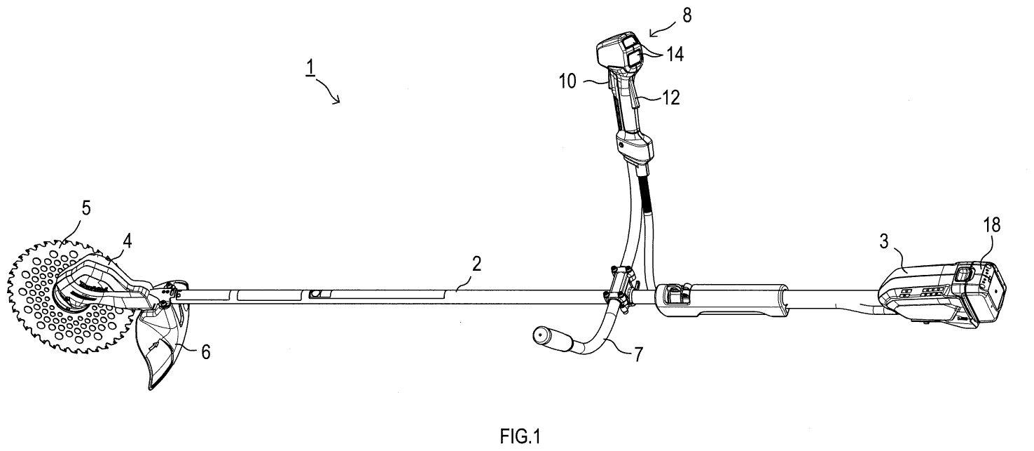

As shown in FIG. 1, an electric work machine 1 includes a main pipe 2. The main pipe 2 has an elongated hollow rod shape.

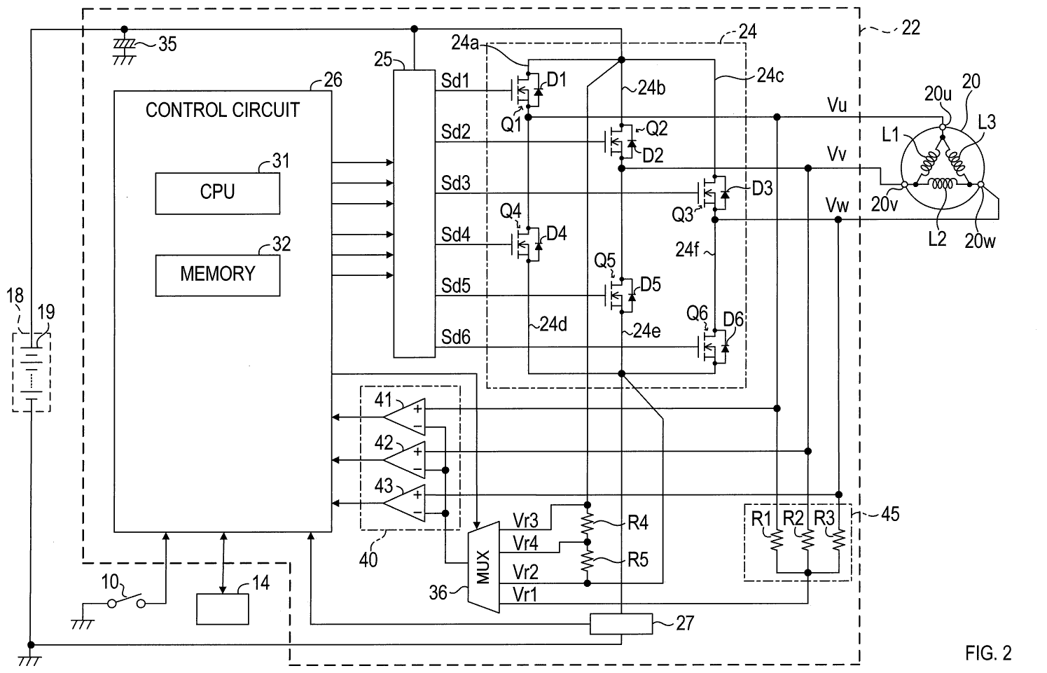

The electric work machine 1 includes a control unit 3 at the rear end of the main pipe 2. The control unit 3 houses a controller 22 (cf. FIG. 2).
The electric work machine 1 includes a drive unit 4 at the front end of the main pipe 2. A rotary blade 5 is detachably attached to the drive unit 4. The rotary blade 5 is configured to mow an object to be mowed, such as grass or small-diameter trees, by being rotated.

The drive unit 4 houses a brushless motor (or a brushless direct current (DC) motor, hereinafter abbreviated as a “motor”) 20 (cf. FIG. 2). The motor 20 receives drive electric power from the controller 22 and rotates. The drive unit 4 houses a driving force transmission mechanism (not shown). The driving force transmission mechanism transmits the rotation of the motor 20 to the rotary blade 5. Thus, when the motor 20 rotates, the rotary blade 5 rotates. The motor 20 is rotated forward or backward. When the motor 20 is rotated forward, the rotary blade 5 is rotated in a direction in which the object to be mowed can be mowed. When the motor 20 is reversely rotated, the rotary blade 5 is rotated in a direction opposite to that during forward rotation.

The electric work machine 1 includes a cover 6 at the front end of the main pipe 2. The cover 6 prevents the object to be mowed or the like from being scattered toward a user of the electric work machine 1 due to rotation of the rotary blades 5.
The electric work machine 1 includes a handle 7. The handle 7 is connected to the main pipe 2 near an intermediate position of the main pipe 2 in the length direction. The handle 7 is gripped by the user.

The electric work machine 1 includes an operation unit 8 at the distal end of a handle 7. The operation unit 8 includes a trigger switch 10. The trigger switch 10 is manually operated by the user. During normal operation when the trigger switch 10 is not manually operated, the trigger switch 10 is turned off. During manual operation when the trigger switch 10 is manually operated, the trigger switch 10 is turned on.

The operation unit 8 includes a lock-off switch 12. The lock-off switch 12 permits or prohibits manual operation of the trigger switch 10. When the lock-off switch 12 is on, manual operation of the trigger switch 10 is permitted. When the lock-off switch 12 is not on, manual operation of the trigger switch 10 is prohibited. The user can manually operate the trigger switch 10 with one hand (e.g., the right hand) while turning on the lock-off switch 12 with the one hand.

The operation unit 8 includes an operation panel 14. Various pieces of information such as an operation state and an operation mode of the electric work machine 1 are displayed on the operation panel 14. The operation panel 14 includes one or more push buttons (not shown). The one or more pushbuttons are used, for example, for setting the rotation direction of the motor 20, setting the operation mode of the motor 20, and the like.

The control unit 3 is configured such that a battery pack 18 can be detachably attached to the rear end thereof. The battery pack 18 houses a battery 19 (cf. FIG. 2). The battery 19 is, for example, in the form of a repeatedly chargeable secondary battery. The battery 19 is one example of the power source in the overview of the embodiments. The electric work machine 1 operates by receiving battery power from the battery pack 18.

### (2-1-2) Electrical Configuration of Electric Work Machine

An electrical configuration of the electric work machine 1 will be described with reference to FIG. 2. FIG. 2 shows a state in which the battery pack 18 is attached to the electric work machine 1.

The electric work machine 1 includes the motor 20. The motor 20 is in the form of a brushless motor as described above. The motor 20 includes a permanent magnet type rotor (not shown) and a stator (not shown). Specifically, the rotation of the rotor is transmitted to the driving force transmission mechanism described above.

The motor 20 includes a first coil L1, a second coil L2, and a third coil L3 wound around the stator. The drive electric power from the controller 22 is input to the first, second, and third coils L1, L2, L3. The first, second, and third coils L1, L2, L3 are delta-connected to each other. However, the first, second, and third coils L1, L2, L3 may be star-connected to each other.

The motor 20 includes a first terminal 20u, a second terminal 20v, and a third terminal 20w. The first, second, and third terminals 20u, 20v, 20w are examples of the three terminals in the overview of the embodiments. The first terminal 20u is connected to the first end of the first coil L1 and the first end of the third coil L3. The second terminal 20v is connected to the second end of the first coil L1 and the first end of the second coil L2. The third terminal 20w is connected to the second end of the second coil L2 and the second end of the third coil L3. The motor 20 receives the drive electric power via the first, second, and third terminals 20u, 20v, 20w, and thereby rotates. The drive electric power of the present embodiment is in the form of three-phase power. The first terminal 20u corresponds to a terminal to which a U-phase voltage of three-phase power is applied, the second terminal 20v corresponds to a terminal to which a V-phase voltage of three-phase power is applied, and the third terminal 20w corresponds to a terminal to which a W-phase voltage of three-phase power is applied.

The electric work machine 1 includes the controller 22 described above. The controller 22 controls the rotation of the motor 20. The controller 22 is electrically coupled to the motor 20, the trigger switch 10, and the operation panel 14. The controller 22 is electrically coupled to the battery 19 and receives battery power from the battery 19.

The controller 22 includes a drive circuit 24. The drive circuit 24 is electrically coupled to the positive electrode and the negative electrode of the battery 19, and receives battery power from the battery 19.
The drive circuit 24 is coupled to the first to third terminals 20u to 20w of the motor 20. The drive circuit 24 (i) generates the drive electric power from battery power, and (ii) supplies the drive electric power to the motor 20.

The drive circuit 24 of the present embodiment is in the form of a three-phase full-bridge circuit. That is, the drive circuit 24 includes a first current path 24a, a second current path 24b, a third current path 24c, a fourth current path 24d, a fifth current path 24e, and a sixth current path 24f. The first, second, and third current paths 24a, 24b, 24c are examples of the three positive-electrode-side paths in the overview of the embodiments. The fourth, fifth, and sixth current paths 24d, 24e, 24f are examples of the three negative-electrode-side paths in the overview of the embodiments.

The first current path 24a electrically couples the first terminal 20u of the motor 20 to the positive electrode of the battery 19. The second current path 24b electrically couples the second terminal 20v of the motor 20 to the positive electrode of the battery 19. The third current path 24c electrically couples the third terminal 20w of the motor 20 to the positive electrode of the battery 19. The fourth current path 24d electrically couples the first terminal 20u of the motor 20 to the negative electrode of the battery 19. The fifth current path 24e electrically couples the second terminal 20v of the motor 20 to the negative electrode of the battery 19. The sixth current path 24f electrically couples the third terminal 20w of the motor 20 to the negative electrode of the battery 19.

The drive circuit 24 includes a first switch Q1, a second switch Q2, a third switch Q3, a fourth switch Q4, a fifth switch Q5, and a sixth switch Q6.
Each of the first to sixth switches Q1 to Q6 may have any form. In the present embodiment, each of the first to sixth switches Q1 to Q6 is in the form of, for example, an n-channel metal-oxide-semiconductor field-effect transistor (MOSFET).

Therefore, each of the first to sixth switches Q1 to Q6 includes a so-called body diode (or parasitic diode). That is, the first switch Q1 includes a first body diode D1, the second switch Q2 includes a second body diode D2, the third switch Q3 includes a third body diode D3, the fourth switch Q4 includes a fourth body diode D4, the fifth switch Q5 includes a fifth body diode D5, and the sixth switch Q6 includes a sixth body diode D6. Each of the first, second, and third body diodes D1, D2, D3 is one example of the first rectifier in the overview of the embodiments. Each of the fourth to sixth body diodes D4, D5, D6 is one example of the second rectifier in the overview of the embodiments.

The first switch Q1 is provided on the first current path 24a. Specifically, the first end (i.e., drain) of the first switch Q1 is electrically coupled to the positive electrode of the battery 19 via the first current path 24a. The second end (i.e., source) of the first switch Q1 is electrically coupled to the first terminal 20u of the motor 20 via the first current path 24a.

The first switch Q1 completes or interrupts the first current path 24a. When the first switch Q1 is turned on, the first current path 24a is completed, and when the first switch Q1 is turned off, the first current path 24a is interrupted. However, in the present embodiment, even when the first switch Q1 is turned off, an electric current can flow via the first body diode D1. That is, even when the first switch Q1 is turned off, the electric current can flow from the second end to the first end of the first switch Q1 through the first body diode D1. The first switch Q1 is turned on or off based on a first drive signal Sd1 input from a gate circuit 25.

The second switch Q2 is provided on the second current path 24b. Specifically, the first end (i.e., drain) of the second switch Q2 is electrically coupled to the positive electrode of the battery 19 via the second current path 24b. The second end (i.e., source) of the second switch Q2 is electrically coupled to the second terminal 20v of the motor 20 via the second current path 24b.

The second switch Q2 completes or interrupts the second current path 24b. When the second switch Q2 is turned on, the second current path 24b is completed, and when the second switch Q2 is turned off, the second current path 24b is interrupted. However, in the present embodiment, even when the second switch Q2 is turned off, an electric current can flow via the second body diode D2. That is, even when the second switch Q2 is turned off, the electric current can flow from the second end to the first end of the second switch Q2 through the second body diode D2. The second switch Q2 is turned on or off based on a second drive signal Sd2 input from the gate circuit 25.

The third switch Q3 is provided on the third current path 24c. Specifically, the first end (i.e., drain) of the third switch Q3 is electrically coupled to the positive electrode of the battery 19 via the third current path 24c. The second end (i.e., source) of the third switch Q3 is electrically coupled to the third terminal 20w of the motor 20 via the third current path 24c.

The third switch Q3 completes or interrupts the third current path 24c. When the third switch Q3 is turned on, the third current path 24c is completed, and when the third switch Q3 is turned off, the third current path 24c is interrupted. However, in the present embodiment, even when the third switch Q3 is turned off, an electric current can flow via the third body diode D3. That is, even when the third switch Q3 is turned off, the electric current can flow from the second end to the first end of the third switch Q3 through the third body diode D3. The third switch Q3 is turned on or off based on a third drive signal Sd3 input from the gate circuit 25.

The fourth switch Q4 is provided on the fourth current path 24d. Specifically, the first end (i.e., drain) of the fourth switch Q4 is electrically coupled to the first terminal 20u of the motor 20 via the fourth current path 24d. The second end (i.e., source) of the fourth switch Q4 is electrically coupled to the negative electrode of the battery 19 via the fourth current path 24d.

The fourth switch Q4 completes or interrupts the fourth current path 24d. When the fourth switch Q4 is turned on, the fourth current path 24d is completed, and when the fourth switch Q4 is turned off, the fourth current path 24d is interrupted. However, in the present embodiment, even when the fourth switch Q4 is turned off, an electric current can flow via the fourth body diode D4. That is, even when the fourth switch Q4 is turned off, the electric current can flow from the second end to the first end of the fourth switch Q4 through the fourth body diode D4. The fourth switch Q4 is turned on or off based on a fourth drive signal Sd4 input from the gate circuit 25.

The fifth switch Q5 is provided on the fifth current path 24e. Specifically, the first end (i.e., drain) of the fifth switch Q5 is electrically coupled to the second terminal 20v of the motor 20 via the fifth current path 24e. The second end (i.e., source) of the fifth switch Q5 is electrically coupled to the negative electrode of the battery 19 via the fifth current path 24e.

The fifth switch Q5 completes or interrupts the fifth current path 24e. When the fifth switch Q5 is turned on, the fifth current path 24e is completed, and when the fifth switch Q5 is turned off, the fifth current path 24e is interrupted. However, in the present embodiment, even when the fifth switch Q5 is turned off, an electric current can flow via the fifth body diode D5. That is, even when the fifth switch Q5 is turned off, the electric current can flow from the second end to the first end of the fifth switch Q5 through the fifth body diode D5. The fifth switch Q5 is turned on or off based on a fifth drive signal Sd5 input from the gate circuit 25.

The sixth switch Q6 is provided on the sixth current path 24f. Specifically, the first end (i.e., drain) of the sixth switch Q6 is electrically coupled to the third terminal 20w of the motor 20 via the sixth current path 24f. The second end (i.e., source) of the sixth switch Q6 is electrically coupled to the negative electrode of the battery 19 via the sixth current path 24f.

The sixth switch Q6 completes or interrupts the sixth current path 24f. When the sixth switch Q6 is turned on, the sixth current path 24f is completed, and when the sixth switch Q6 is turned off, the sixth current path 24f is interrupted. However, in the present embodiment, even when the sixth switch Q6 is turned off, an electric current can flow via the sixth body diode D6. That is, even when the sixth switch Q6 is turned off, the electric current can flow from the second end to the first end of the sixth switch Q6 through the sixth body diode D6. The sixth switch Q6 is turned on or off based on a sixth drive signal Sd6 input from the gate circuit 25.

Here, a U-phase line current, a V-phase line current, and a W-phase line current are defined. The U-phase line current is an electric current flowing between the drive circuit 24 and the first terminal 20u of the motor 20. That is, the U-phase line current is an electric current flowing into the first terminal 20u of the motor 20 and an electric current flowing out of the first terminal 20u of the motor 20. In the following description, with respect to the direction of the U-phase line current, a direction of flow toward the first terminal 20u is defined as a “positive direction” (+), and a direction of flow out of the first terminal 20u is defined as a “negative direction” (−).

The V-phase line current is an electric current flowing between the drive circuit 24 and the second terminal 20v of the motor 20. That is, the V-phase line current is an electric current flowing into the second terminal 20v of the motor 20 and an electric current flowing out of the second terminal 20v of the motor 20. In the following description, with respect to the direction of the V-phase line current, a direction of flow toward the second terminal 20v is defined as a “positive direction” (+), and a direction of flow out of the second terminal 20v is defined as a “negative direction” (−).

The W-phase line current is an electric current flowing between the drive circuit 24 and the third terminal 20w of the motor 20. That is, the W-phase line current is an electric current flowing into the third terminal 20w of the motor 20 and an electric current flowing out of the third terminal 20w of the motor 20. In the following description, with respect to the direction of the W-phase line current, a direction of flow toward the third terminal 20w is defined as a “positive direction” (+), and a direction of flow out of the third terminal 20w is defined as a “negative direction” (−).

The controller 22 includes a gate circuit 25. The gate circuit 25 receives first to sixth control signals from a control circuit 26. The gate circuit 25 generates the first drive signal Sd1 corresponding to the first control signal, generates the second drive signal Sd2 corresponding to the second control signal, generates the third drive signal Sd3 corresponding to the third control signal, generates the fourth drive signal Sd4 corresponding to the fourth control signal, generates the fifth drive signal Sd5 corresponding to the fifth control signal, and generates the sixth drive signal Sd6 corresponding to the sixth control signal. The first to sixth control signals control the first to sixth switches Q1 to Q6 (and thus control the motor 20). The first to sixth control signals may include a pulse-width modulation signal (PWM signal).

The first control signal and the first drive signal Sd1 are in the form of a binary signal (digital signal). The logic level of the first drive signal Sd1 may be the same as the logic level of the first control signal. The gate circuit 25 outputs the input first control signal to the drive circuit 24 as the first drive signal Sd1, for example, amplified or at the same level. In the present embodiment, the first drive signal Sd1 may be regarded as being equal to (or equivalent to) the first control signal.

The correspondence relationship between the second to sixth control signals and the second to sixth drive signals Sd2 to Sd6 is the same as the correspondence relationship between the first control signal and the first drive signal Sd1 described above. The gate circuit 25 may be included in the control circuit 26. In this case, the first to sixth drive signals Sd1 to Sd6 may be output from the control circuit 26.

The controller 22 includes a current detection circuit 27. The current detection circuit 27 is on an current path from the drive circuit 24 to the negative electrode of the battery 19. The current detection circuit 27 outputs a current detection signal. The current detection signal indicates a value (or magnitude; hereinafter referred to as a “motor current value”) of electric current flowing through the current path. The current detection signal is input to the control circuit 26.

The controller 22 includes a reference voltage generation circuit 45. The reference voltage generation circuit 45 generates a first reference voltage Vr1. The first reference voltage Vr1 corresponds to a voltage of a virtual neutral point of the motor 20.

The reference voltage generation circuit 45 includes a first resistor R1, a second resistor R2, and a third resistor R3. The first end of the first resistor R1 is electrically coupled to the first terminal 20u of the motor 20. The first end of the second resistor R2 is electrically coupled to the second terminal 20v of the motor 20. The first end of the third resistor R3 is electrically coupled to the third terminal 20w of the motor 20. The second end of the first resistor R1, the second end of the second resistor R2, and the second end of the third resistor R3 are electrically coupled (or connected) to each other. The voltages at the second ends of the first to third resistors R1 to R3 are output as a first reference voltage Vr1. The first reference voltage Vr1 is input to a selection circuit 36.

The controller 22 includes a fourth resistor R4 and a fifth resistor R5. The fourth resistor R4 and the fifth resistor R5 are connected in series with each other. The first end of the fourth resistor R4 is electrically coupled to a positive electrode connection line in the drive circuit 24. The positive electrode connection line is electrically electrically coupled to the positive electrode of the battery 19. The first end of each of the first to third switches Q1 to Q3 is electrically coupled to the positive electrode connection line. The second end of the fourth resistor R4 is electrically coupled to the first end of the fifth resistor R5. The second end of the fifth resistor R5 is electrically coupled to the negative electrode connection line in the drive circuit 24. The negative electrode connection line is electrically electrically coupled to the negative electrode of the battery 19. The second ends of the fourth to sixth switches Q4 to Q6 are electrically coupled to the negative electrode connection line.

The voltage of the second end of the fifth resistor R5 (i.e., the voltage of the negative electrode connection line) is input as a second reference voltage Vr2 to the selection circuit 36, which will be described later. The voltage of the first end of the fourth resistor R4 (i.e., the voltage of the positive electrode connection line) is input to the selection circuit 36 as a third reference voltage Vr3. The voltage of the second end of the fourth resistor R4 is input to the selection circuit 36 as a fourth reference voltage Vr4. The fourth reference voltage Vr4 corresponds to a voltage obtained by dividing a voltage between the positive electrode connection line and the negative electrode connection line by the fourth and fifth resistors R4, R5. The voltage division ratio may be determined in any manner. The partial pressure ratio may be, for example, one-half.

The controller 22 includes the selection circuit 36. The selection circuit 36 receives the first to fourth reference voltages Vr1 to Vr4. The selection circuit 36 outputs one of the first to fourth reference voltages Vr1 to Vr4 as a reference voltage. The selection circuit 36 of the present embodiment is in the form of a multiplexer. The selection circuit 36 selects a reference voltage to be output as a reference voltage according to a switching signal input from the control circuit 26.

The controller 22 includes a current information acquisition circuit 40. The current information acquisition circuit 40 receives a first voltage Vu, a second voltage Vv, and a third voltage Vw. The first voltage Vu is a voltage of the first terminal 20u of the motor 20. The second voltage Vv is a voltage of the second terminal 20v of the motor 20. The third voltage Vw is a voltage of the third terminal 20w of the motor 20. The first, second, and third voltages Vu, Vv, Vw are examples of the current information in the overview of the embodiments.

The current information acquisition circuit 40 generates first comparison information corresponding to the magnitude of the input first voltage Vu, and outputs the first comparison information to the control circuit 26. The current information acquisition circuit 40 generates second comparison information corresponding to the magnitude of the input second voltage Vv, and outputs the second comparison information to the control circuit 26. The current information acquisition circuit 40 generates third comparison information corresponding to the magnitude of the input third voltage Vw, and outputs the third comparison information to the control circuit 26.

More specifically, the current information acquisition circuit 40 includes a first comparator 41, a second comparator 42, and a third comparator 43.
The first comparator 41 receives the first voltage Vu and the reference voltage from the selection circuit 36. The first comparator 41 compares the value of the first voltage Vu with the value of the reference voltage, and outputs first comparison information corresponding to the comparison result. The first comparison information is a binary signal. When the value of the first voltage Vu is greater than or equal to the value of the reference voltage, the first comparator 41 outputs H-level (high-level) first comparison information. When the value of the first voltage Vu is less than the value of the reference voltage, the first comparator 41 outputs L-level (low level) first comparison information.

The second comparator 42 receives the second voltage Vv and the reference voltage from the selection circuit 36. The second comparator 42 compares the value of the second voltage Vv with the value of the reference voltage, and outputs second comparison information corresponding to the comparison result. The second comparison information is a binary signal. When the value of the second voltage Vv is greater than or equal to the value of the reference voltage, the second comparator 42 outputs H-level second comparison information. When the value of the second voltage Vv is less than the value of the reference voltage, the second comparator 42 outputs L-level second comparison information.

The third comparator 43 receives the third voltage Vw and the reference voltage from the selection circuit 36. The third comparator 43 compares the value of the third voltage Vw with the value of the reference voltage, and outputs third comparison information corresponding to the comparison result. The third comparison information is a binary signal. When the value of the third voltage Vw is greater than or equal to the value of the reference voltage, the third comparator 43 outputs H-level third comparison information. When the value of the third voltage Vw is less than the value of the reference voltage, the third comparator 43 outputs L-level third comparison information.

The controller 22 includes the control circuit 26. The control circuit 26 of the present embodiment includes, for example, a microcomputer including a central processing unit (CPU) 31 and a memory 32. The memory 32 may include a semiconductor memory such as read-only memory (ROM), random-access memory (RAM), non-volatile random-access memory (NVRAM), or flash memory.

The control circuit 26 implements various functions by executing a program stored in a non-transitory tangible recording medium. In the present embodiment, the memory 32 corresponds to a non-transitory tangible recording medium storing a program. In the present embodiment, the memory 32 stores programs of various processes, which will be described later.

Some or all of the various functions implemented by the control circuit 26 may be achieved by execution of a program (i.e., by software processing), or may be achieved by one or a plurality of pieces of hardware. For example, the control circuit 26 may be provided with a logic circuit (or wired logic connection) including two or more electronic components instead of or in addition to the microcomputer. That is, the logic circuit may achieve some or all of the various functions of the control circuit 26. The logic circuit may include an ASIC, an ASSP, and/or a programmable logic device. Examples of programmable logic devices include FPGAs.

The control circuit 26 receives a trigger signal from the trigger switch 10. The trigger signal indicates whether the trigger switch 10 is on or off. The trigger signal may include information indicating the amount of movement of the trigger switch 10.

The control circuit 26 is electrically coupled to the operation panel 14. The control circuit 26 executes various processes based on various signals input from the operation panel 14. The control circuit 26 displays, on the operation panel 14, various types of information such as an operation state and an operation mode of the electric work machine 1.

The control circuit 26 receives a current detection signal from the current detection circuit 27. The control circuit 26 executes various processes based on the motor current value indicated by the current detection signal.
The control circuit 26 outputs a switching signal to the selection circuit 36 according to the operating state of the electric work machine 1, thereby designating the reference voltage. In the present embodiment, the control circuit 26 basically sets the fourth reference voltage Vr4 as the reference voltage during execution of the driving operation. The driving operation is an operation of driving the motor 20. On the other hand, during execution of the braking operation, the control circuit 26 sets one of the first to third reference voltages Vr1 to Vr3 as the reference voltage. The braking operation is an operation of braking the motor 20.

The control circuit 26 receives the first, second, and third comparison information from the current information acquisition circuit 40. Based on the first, second, and third comparison information, the control circuit 26 executes the driving operation and the braking operation described above.

### (2-1-3) Motor Control by Control Circuit

The driving operation and the braking operation executed by the control circuit 26 will be described in more detail.

### (2-1-3-1) Driving Operation

The control circuit 26 executes the driving operation to rotate the motor 20 based on a drive requirement being satisfied. The drive requirement includes at least that the trigger switch 10 is turned on.

To rotate the motor 20, the control circuit 26 needs to know the electric angle (in other words, the rotational position) of the motor 20 (specifically, of the rotor). Methods for detecting the electric angle of the motor 20 mainly include a method using a Hall sensor and a method using a back-EMF (or an induced voltage) of the motor 20 (so-called sensorless method).

In the electric work machine 1 of the present embodiment, the electric angle is detected by a sensorless method. The electric work machine 1 of the present embodiment does not include a physical detection device such as a Hall sensor for detecting an electric angle.

In the driving operation, the control circuit 26 detects the electric angle of the motor 20 based on the back-EMF of the motor 20 generated in each of the first, second, and third ends 20u, 20v, 20w of the motor 20. Then, the drive circuit 24 is controlled according to the electric angle, thereby rotating the motor 20.

More specifically, the control circuit 26 causes the selection circuit 36 to set the fourth reference voltage Vr4 as the reference voltage. That is, the control circuit 26 controls the selection circuit 36 so that the first, second, and third comparison information based on the fourth reference voltage Vr4 is input to the control circuit 26. Then, the control circuit 26 detects the electric angle of the motor 20 based on the first, second, and third comparison information. The first, second, and third comparison information includes information on the back-EMF of the motor 20. This enables the electric angle to be detected from the first, second, and third comparison information.

When the motor 20 rotates at a low speed, at or below a predetermined rotational speed, the control circuit 26 may control the rotation of the motor 20 using the current detection signal without using the first, second, and third comparison information. In the following description, the angle may be expressed as, for example, “120°”, and the like, and the angle in this case represents the electric angle of the motor 20.

### (2-1-3-2) Braking Operation

When the braking requirement is satisfied, the control circuit 26 executes the braking operation to decelerate and/or stop the motor 20. The braking requirement includes that the trigger switch 10 is turned off during the rotation of the motor 20.

In the braking operation, one of free running, two-phase dynamic braking (or two-phase short-circuit braking), and three-phase dynamic braking (or three-phase short-circuit braking) is used as a braking method for decelerating the motor 20. In two-phase dynamic braking and three-phase dynamic braking, an electric current caused by the back-EMF of the motor 20 flows between the motor 20 and the drive circuit 24, thereby braking the motor 20. This electric current may be referred to as a “brake current”in the following description.

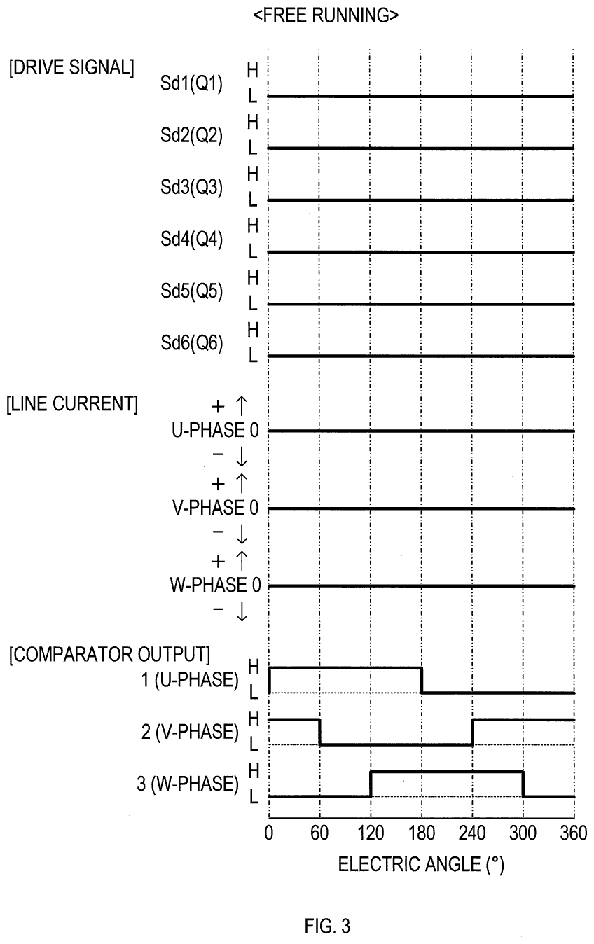

As illustrated in FIG. 3, free running includes setting all of the first to sixth drive signals Sd1 to Sd6 to the L level, thereby turning off all of the first to sixth switches Q1 to Q6. When free running is being performed, the U-phase line current, the V-phase line current, and the W-phase line current do not flow. FIG. 3 shows an operation example of free running when the motor 20 rotates in the forward direction.

That the drive signal is at the L level means that the corresponding switch is off, and that the drive signal is at the H level means that the corresponding switch is on. In “Comparator output” in the waveform diagrams of FIG. 3 and subsequent drawings, “1 (U phase)” means the first comparison information (i.e., the output of the first comparator 41), “2 (V phase)” means the second comparison information (i.e., the output of the second comparator 42), and “3 (W-phase)” means the third comparison information (i.e., the output of the third comparator 43).

The control circuit 26 sets the reference voltage to the first reference voltage Vr1 during execution of free running. Then, free running is executed while the electric angle of the motor 20 is detected based on the first, second, and third comparison information.

The three-phase dynamic braking includes low-side three-phase dynamic braking and high-side three-phase dynamic braking.
The low-side three-phase dynamic braking includes turning on three low-side switches and turning off three high-side switches. The “three low-side switches” means the fourth to sixth switches Q4 to Q6. In low-side three-phase dynamic braking, the brake current flows between the motor 20 and the three low-side switches.

The high-side three-phase dynamic braking includes turning on the three high-side switches and turning off the three low-side switches. The “three high-side switches” means the first to third switches Q1 to Q3. In high-side three-phase dynamic braking, the brake current flows between the motor 20 and the three high-side switches.

When executing three-phase dynamic braking, the control circuit 26 executes either low-side three-phase dynamic braking or high-side three-phase dynamic braking. For example, the control circuit 26 may be configured to execute only low-side three-phase dynamic braking, may be configured to execute only high-side three-phase dynamic braking, or may be configured to selectively execute low-side three-phase dynamic braking and high-side three-phase dynamic braking (e.g., alternately according to the rotation of the motor 20).

The control circuit 26 sets the reference voltage to the first reference voltage Vr1 or the second reference voltage Vr2 during execution of low-side three-phase dynamic braking. Low-side three-phase dynamic braking is executed while the electric angle of the motor 20 is detected based on the first, second, and third comparison information.

The control circuit 26 sets the reference voltage to the first reference voltage Vr1 or the third reference voltage Vr3 during execution of high-side three-phase dynamic braking. High-side three-phase dynamic braking is executed while the electric angle of the motor 20 is detected based on the first, second, and third comparison information.

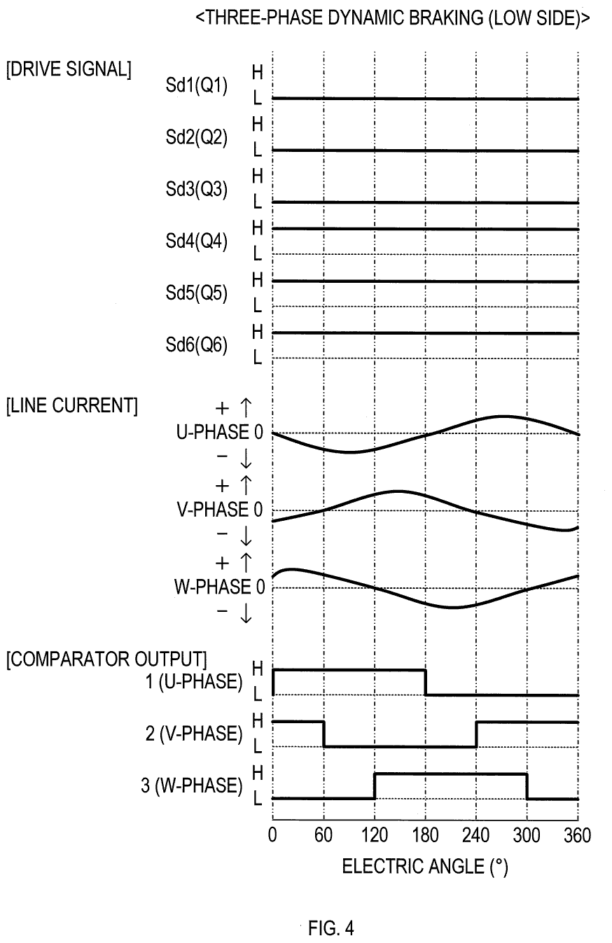

FIG. 4 shows an operation example of low-side three-phase dynamic braking when the motor 20 rotates in the forward direction. In low-side three-phase dynamic braking, the U-phase line current, the V-phase line current, and the W-phase line current change as illustrated in FIG. 4 according to the rotation angle of the motor 20. The first, second, and third comparison information changes as illustrated in FIG. 4 according to the rotation angle of the motor 20.

Two-phase dynamic braking includes electrically short-circuiting two of the first to third terminals 20u to 20w of the motor 20 to each other. Specifically, in two-phase dynamic braking, two of the first to sixth switches Q1 to Q6 are turned on and the other four are turned off. The two switches turned on by two-phase dynamic braking are referred to as a “switch pair”.

The two-phase dynamic braking includes low-side two-phase dynamic braking and high-side two-phase dynamic braking.

The low-side two-phase dynamic braking includes turning on a switch pair of the three low-side switches and turning off the other one and the three high-side switches. The high-side two-phase dynamic braking includes turning on a switch pair of the three high-side switches and turning off the other one and the three low-side switches. In two-phase dynamic braking, the brake current flows between the motor and the switch pair.

When executing two-phase dynamic braking, the control circuit 26 executes either low-side two-phase dynamic braking or high-side two-phase dynamic braking. For example, the control circuit 26 may be configured to execute only low-side two-phase dynamic braking, only high-side two-phase dynamic braking, or alternatively execute low-side two-phase dynamic braking and high-side two-phase dynamic braking (e.g., alternately according to the rotation of the motor 20).

The control circuit 26 sets the reference voltage to the first reference voltage Vr1 or the second reference voltage Vr2 during execution of low-side two-phase dynamic braking. Low-side two-phase dynamic braking is executed while the electric angle of the motor 20 is detected based on the first, second, and third comparison information.

The control circuit 26 sets the reference voltage to the first reference voltage Vr1 or the third reference voltage Vr3 during execution of high-side two-phase dynamic braking. High-side two-phase dynamic braking is executed while the electric angle of the motor 20 is detected based on the first, second, and third comparison information.

The switch pair may be fixed regardless of the electric angle of the motor 20. However, the control circuit 26 of the present embodiment is configured to execute the switching operation during execution of the braking operation. The switching operation includes switching the switch pair according to the electric angle of the motor 20.

In the following description, of two switches that are currently set in the switch pair and are on, one switch to be turned off in the next switching operation is referred to as the off-target switch.

In the switching operation, the control circuit 26 switches the switch pair based on the electric current flowing through the off-target switch (hereinafter referred to as “off-target current”) satisfying the off-requirement. Specifically, the off-target switch is turned off, and one switch other than the switch pair that is currently off is turned on.

The off-requirement is satisfied based on the off-target current avoiding a specific state (in other words, not being in a specific state). The specific state is a state in which (i) the off-target current is flowing in a direction opposite to a specific direction and (ii) the magnitude of the off-target current corresponds to an extreme value. The specific direction is a direction from the source to the drain. In other words, the specific direction is a direction corresponding to the forward direction of the body diode. To elaborate, the specific direction is a direction from the negative electrode of the battery 19 toward the motor 20 through the off-target switch in low-side two-phase dynamic braking, and is a direction from the motor 20 toward the positive electrode of the battery 19 through the off-target switch in high-side two-phase dynamic braking.

In two-phase dynamic braking, at least when (i) the off-target current is flowing in the direction opposite to the specific direction (the direction corresponding to the direction opposite to the body diode) and (ii) the value of the off-target current is an extreme value, the off-requirement is not satisfied. This is because when the off-target switch is turned off at such timing, a large regenerative current may flow from the motor 20 to the battery 19. This regenerative current can flow via the switch that is currently on and the body diode of the switch that is in a pair relationship with the off-target switch. Being in a “pair relationship” means that being in a series relationship with each other with respect to the battery 19. For example, the first switch Q1 and the fourth switch Q4 are in a pair relationship with each other.

In the present embodiment, the switch pair is switched so that the flow of the regenerative current is suppressed or prevented at the time of switching the switch pair. This is one of the most characteristic functions of the present embodiment. To implement this, an off-requirement is set, and the switch pair is switched at the timing when the regenerative current is suppressed or not generated.

To further suppress or prevent the generation of the regenerative current, it is desirable to turn off the off-target switch when the electric current in the specific direction is flowing through the off-target switch. In this way, when the off-target switch is turned off, the brake current flowing through the off-target switch can continue to flow through the body diode of the off-target switch, whereby the regeneration to the battery 19 is prevented or greatly suppressed. Thus, in the present embodiment, the off-requirement is more specifically satisfied based on the direction of the off-target current is the specific direction.

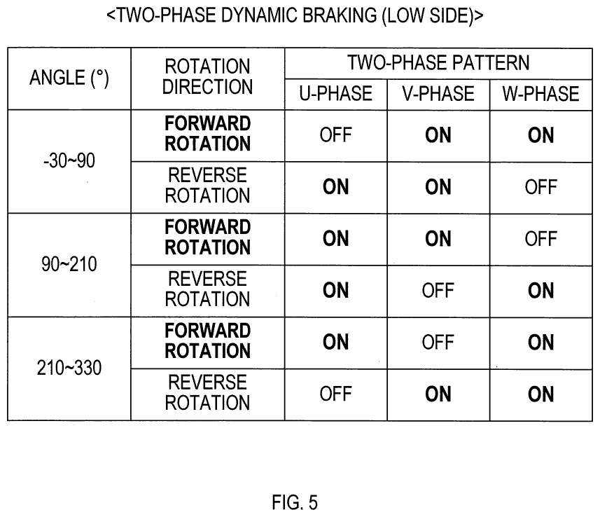

In the present embodiment, the switch pair is switched according to the electric angle so that the off-requirement is satisfied. The control circuit 26 includes a switch pair table as illustrated in FIG. 5. The switch pair table may be stored in the memory 32.

The switch pair table indicates the relationship between the range of the electric angle and the switch pair to be turned on in the range. FIG. 5 shows a switch pair in low-side two-phase dynamic braking. As shown in FIG. 5, in low-side two-phase dynamic braking, the switch pair differs depending on whether the electric angle is 30° or more and less than 90°, 90° or more and less than 210°, or 210° or more and less than 330°. A switch pair table in high-side two-phase dynamic braking is also separately mounted. In FIG. 5, “U phase” means the fourth switch Q4, “V phase” means the fifth switch Q5, and “W-phase” means the sixth switch Q6. As shown in FIG. 5, the switch pair varies depending on the rotation direction of the motor 20.

By switching the switch pair based on the switch pair table of FIG. 5 according to the electric angle, it is possible to turn off the off-target switch in a state where the off-requirement is satisfied.
In the conventionally known configuration in which the electric angle of the motor is detected using the Hall sensor, the electric angle of the motor can be appropriately detected based on the signal from the Hall sensor even during execution of two-phase dynamic braking.

On the other hand, in the present embodiment, there is no Hall sensor, and the electric angle is detected based on the back-EMF. During the driving operation, the electric angle can be appropriately detected based on the back-EMF. On the other hand, during the braking operation, it is difficult to appropriately detect the electric angle based on the back-EMF. That is, during two-phase dynamic braking, the switch pair is simultaneously turned on. This makes it difficult to appropriately detect the back-EMFs being generated in at least two of the first, second, and third terminals 20u, 20v, 20w connected to the switch pair.

However, during the braking operation, the brake current flows through the switch that is on, so that a potential difference is generated between both ends of the switch due to the internal resistance of the switch. This enables the direction of the brake current flowing through the switch from the potential difference to be detected from the potential difference. Specifically, when at least one of both ends of the switch at a higher potential (or a lower potential) can be detected, it is possible to detect in which direction the brake current is flowing through the switch.

For example, the direction of the brake current flowing through the fourth switch Q4 can be detected by comparing the first voltage Vu with the first reference voltage Vr1 or the second reference voltage Vr2. For example, the direction of the brake current flowing through the first switch Q1 can be detected by comparing the first voltage Vu with the first reference voltage Vr1 or the third reference voltage Vr3.

That is, even during the two-phase dynamic braking operation, the direction of the brake current flowing through the switch pair can be detected based on the first, second, and third comparison information from the current information acquisition circuit 40. The first, second, and third comparison information changes according to the rotation of the motor 20 (i.e., according to the electric angle). Thus, at the timing when a comparator edge occurs (hereinafter referred to as “edge timing”), the electric angle of the motor 20 at the edge timing can be detected. The comparator edge is a change in at least one of the first, second, and third comparison information.

Therefore, in the present embodiment, the switch pair is switched based on the first, second, and third comparison information (specifically, according to the occurrence of a comparator edge), thereby implementing the switching at the timing when the off-requirement is satisfied. In other words, switching the switch pair based on the occurrence of a comparator edge results in switching being implemented at the timing when the off-requirement is satisfied. That is, the occurrence of a comparator edge means that the brake current in the specific direction is flowing through the off-target switch (i.e., the off-requirement is satisfied). The edge timing is one example of the off-available timing in the overview of the embodiments.

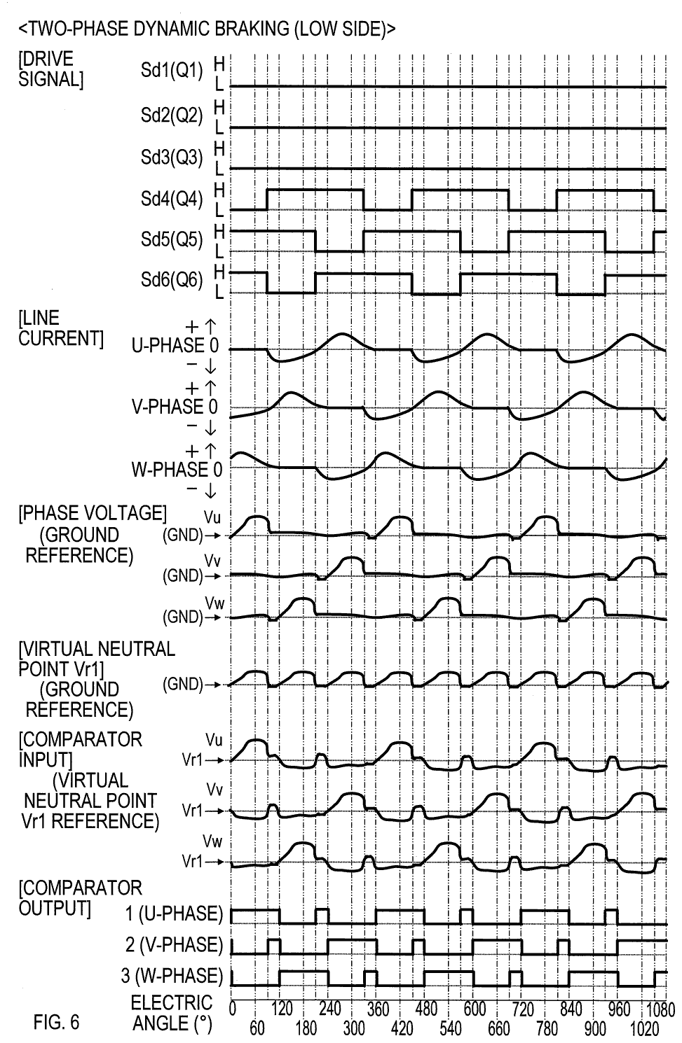

FIG. 6 shows an operation example of two-phase dynamic braking when the motor 20 rotates in the forward direction. In FIG. 6, for example, 120°, 240°, 360°, 480°, 600°. correspond to the edge timing.

In FIG. 6, “Phase voltage” is the first, second, and third voltages Vu, Vv, Vw. FIG. 6 illustrates changes in the first, second, and third voltages Vu, Vv, Vw with reference to the potential of the ground. In the present embodiment, the potential of the ground is the same as that of the negative electrode of the battery 19. The voltage of the negative electrode line in the drive circuit 24 (i.e., second reference voltage Vr2) may also be treated as being the same as the potential of the ground.

In FIG. 6, “Virtual neutral point Vr1” is the first reference voltage Vr1, that is, the reference voltage in the present embodiment. FIG. 6 illustrates a change in the first reference voltage Vr1 with reference to the potential of the ground.

In FIG. 6, “Comparator input” is the first, second, and third voltages Vu, Vv, Vw input to the first to third comparators 41 to 43, respectively. FIG. 6 illustrates changes in the first, second, and third voltages Vu, Vv, Vw with reference to the potential of the virtual neutral point (i.e., first reference voltage Vr1).

Due to the circuit configuration, even at the point when the switch pair is switched by the switching operation, a comparator edge occurs through the switching operation. However, in the present embodiment, the comparator edge at the time of the switching operation is ignored, and in terms of control, this is not treated as a comparator edge having occurred. For example, in FIG. 6, the switching operation is performed at 210°, whereby the first comparison information changes (changes to the H level) at 210°. However, this change is associated with the switching operation and, thus, is not treated as a comparator edge. The same applies to changes in comparison information at 90°, 330°, 450°, 570°. and the like.

At the edge timing, the voltage of the terminal of the off-target switch on the motor 20 side is lower than the reference voltage. This means that the brake current in the specific direction is flowing through the off-target switch. For example, at the timing of 240° in FIG. 6, the brake current in the specific direction is flowing through the fourth switch Q4 (i.e., off-target switch). This enables the off-target switch to be turned off at this timing.

The edge timing is timing at which the value of the voltage of the terminal on the motor 20 side in one switch other than the switch pair reaches the value of the reference voltage. For example, at the timing of 240° in FIG. 6, the brake current flowing through the fifth switch Q5 (i.e., one switch other than the switch pair) reaches zero, and accordingly, the second comparison information changes (changes to the H level). Therefore, it can be said that the change in the comparison information corresponding to one switch other than the switch pair indirectly indicates that the brake current is flowing through the off-target switch in the specific direction.

Therefore, the occurrence of a comparator edge can be said to be timing when (i) the value of the voltage of the terminal on the motor 20 side in the off-target switch is smaller than the value of the reference voltage, and (ii) the value of the voltage of the terminal on the motor 20 side in one of the switches other than the switch pair becomes greater than or equal to the value of the reference voltage.

When a comparator edge occurs, the switch pair may be switched immediately. For example, in FIG. 6, the fourth switch Q4 may be immediately turned off and the fifth switch Q5 may be turned on at the timing of 240°. This is because, at this point, the electric current in the specific direction (in other words, the U-phase line current in the positive direction) is already flowing through the fourth switch Q4, which is the off-target switch. Even when the fourth switch Q4 is turned off at this point, the brake current can continue to flow via the fourth body diode D4. Thus, regeneration is prevented or suppressed.

However, the higher the brake current flowing through the fourth body diode D4 and the longer the time that the brake current flows, the greater the load on the fourth body diode D4. Specifically, for example, the amount of heat generated by the fourth body diode D4 increases. Therefore, the fourth switch Q4 is desirably turned off when the brake current in the specific direction that is flowing through the fourth switch Q4 is as small as possible or zero.

Therefore, in the present embodiment, the control circuit 26 waits for a delay time after the occurrence of the comparator edge, and switches the switch pair when the delay time has elapsed. That is, the off-requirement is satisfied based on not only the occurrence of the comparator edge but also the lapse of the delay time from the occurrence of the comparator edge. The purpose of waiting for the delay time is to wait for the brake current flowing through the off-target switch in the specific direction to decrease.

The delay time is determined so that the delay time elapses when the motor 20 rotates by a desired delay angle from the edge timing. The delay angle is determined so that the magnitude of the brake current flowing through the off-target switch tends to decrease or becomes zero at the time of rotation by the delay angle from the edge timing.

In the present embodiment, the delay angle is set to 90°. That is, at the time of rotation by 90° from the position where the comparator edge has occurred, the off-target switch is turned off (i.e., the switch pair is switched).

However, it is difficult to detect, during the braking control, a position of the motor 20 that has rotated by 90° from the position where the comparator edge has occurred. Therefore, in the present embodiment, when the comparator edge occurs, the control circuit 26 estimates the angular velocity (in other words, the rotational speed) of the motor 20 based on the elapsed time from the previous (i.e. immediately preceding) edge timing to the present edge timing and the electric angle (120° in the present embodiment) therebetween. For example, the angular velocity can be estimated by dividing the elapsed time by the electric angle. Then, the control circuit 26 calculates the time required to rotate by 90° on the assumption that the motor 20 continues to rotate at the estimated angular velocity. The control circuit 26 sets the calculation result as the delay time. Hence, the lower the estimated angular velocity, the longer the delay time.

In the example of FIG. 6, after the occurrence of the comparator edge at 240°, the fourth switch Q4 is turned off at the timing of 330°, at which the delay time has elapsed (i.e., the rotation has been made by 90°). At 330°, the brake current flowing through the fourth switch Q4 in the specific direction is close to zero. That is, strictly speaking, the off-requirement of the present embodiment is satisfied as the delay time elapses from the edge timing (i.e., the rotation is made by the delay angle).

The delay angle is desirably set so that the switching operation is performed before the brake current in the specific direction that is flowing through the off-target switch becomes zero. For example, in FIG. 6, the delay angle from 240° is desirably set before 360°. The reason is as follows.

At 240°, the fourth switch Q4 is newly set as the off-target switch. The brake current in the fourth switch Q4 after 240° (i) gradually increases according to the rotation of the motor 20, (ii) then begins to decrease, and (iii) becomes substantially zero at 360°. When the switching operation is not performed even after 720°, the direction of the brake current in the fourth switch Q4 changes to the direction opposite to the specific direction. Thus, when the fourth switch Q4 is turned off after 360°, a regenerative current may be generated. Therefore, it is desirable to set the delay angle so that the switching operation is performed when the brake current in the specific direction is flowing through the off-target switch.

Two-phase dynamic braking in the present embodiment has the above characteristics. Therefore, while the sensorless system is employed, the switching operation can be performed at an appropriate timing corresponding to the electric angle in two-phase dynamic braking.

The operation example of FIG. 6 will be described again in a supplementary manner. In FIG. 6, a comparator edge occurs at, for example, 360°. At this time, the switch pair is the fifth and sixth switches Q5, Q6, and the off-target switch is the sixth switch Q6. Although the switching operation may be performed at the timing of 360°, the delay time is set in the present embodiment. Then, the switching operation is performed at the timing (at or near 450°) when the delay time has elapsed. Specifically, the switch pair is switched to the fourth and fifth switches Q4, Q5, and the sixth switch Q6 is turned off. At this time, the brake current flowing through the sixth switch Q6 is in the specific direction and is also close to zero or substantially zero. Thus, in addition to preventing or suppressing the occurrence of regeneration, the electric current flowing through the sixth body diode D6 is also suppressed. Thereafter, a similar process is performed each time a comparator edge occurs.

### (2-1-4) Operation Example During Change From Driving Operation to Braking Operation

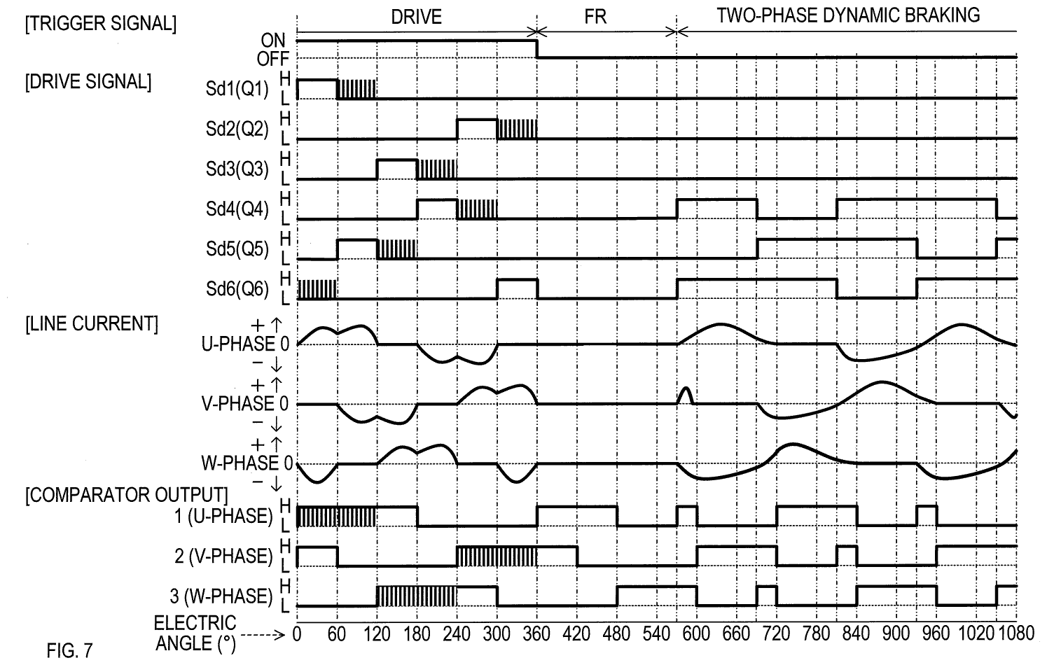

An operation example of the motor 20 will be described with reference to FIG. 7. FIG. 7 illustrates a case where low-side two-phase dynamic braking is performed in the braking operation during the forward rotation.

In the example of FIG. 7, up to 360°, the driving operation is being performed by satisfying the drive requirement. At 360°, the trigger switch 10 is turned off. This satisfies the braking requirement.

When the braking requirement is satisfied, two-phase dynamic braking may be started without performing free running. However, in the present embodiment, first, the motor 20 is braked with a weak braking force by free running for a short time, and then two-phase dynamic braking is executed.

In the example of FIG. 7, the motor 20 is braked by free running from 360° to 570°. After 570°, two-phase dynamic braking is started. That is, two-phase dynamic braking is started after a comparator edge occurs twice from the start of the braking operation.

Specifically, after trigger-off, the first comparator edge occurs at 420°. Here, a measurement timer is started. The measurement timer is used to measure the occurrence interval of the comparator edge. The measurement timer is simply used for time measurement, and does not cause a timer interrupt to occur unlike a commutation timer, which will be described later.

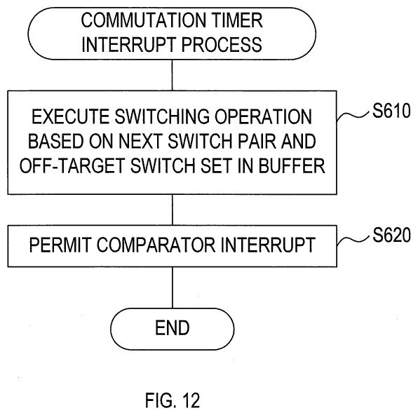

Thereafter, the second comparator edge occurs at 480°. Here, the delay time is set, and a commutation timer based on the delay time is started. The commutation timer is used to cause a timer interrupt to occur. That is, when the timer value of the commutation timer reaches the delay time after the commutation timer starts, a timer interrupt occurs. Specifically, a commutation timer interrupt process in FIG. 12, which will be described later, is executed. Thus, the switch pair switching operation is performed. The delay time is calculated based on the value of the measurement timer at the edge timing of 480°. The value of the measurement timer at 480° represents the time from the previous occurrence of the comparator edge (i.e., 420°) to the present occurrence of the comparator edge (i.e., 480°), that is, the edge occurrence interval. An angular velocity is calculated based on the edge occurrence interval, and a delay time corresponding to the delay angle is calculated based on the angular velocity. Then, the commutation timer starts, and at the timing when the delay time has elapsed (at or near 570°), a commutation timer interrupt occurs. The switch pair corresponding to 570° is turned on by the commutation timer interrupt. As a result, two-phase dynamic braking is started.

At 570°, the fourth and sixth switches Q4, Q6 are turned on. At this time, since the next switch pair is the fifth and sixth switches Q5, Q6, the fourth switch Q4 becomes the off-target switch.

After two-phase dynamic braking is started at 570°, a comparator edge occurs at 600°. The switching operation may be performed at this edge timing, but at this edge timing, the delay time is set in the same manner as when the comparator edge occurs at 480°. Then, the switching operation is performed at the timing (at or near 690°) when the delay time elapses from the edge timing. By this switching operation, the switch pair is switched to the fifth and sixth switches Q5, Q6, and the fourth switch Q4 is turned off. At this time, the brake current flowing through the fourth switch Q4 is flowing in the specific direction and is also close to zero or substantially zero. Thus, in addition to preventing or suppressing the occurrence of regeneration, the electric current flowing through the fourth body diode D4 is also suppressed. Thereafter, a similar process is performed each time a comparator edge occurs.

### (2-1-5) Various Processes by Control Circuit

Each process executed by the control circuit 26 to implement the various operations described above will be described. The memory 32 stores a program of each process described below. The various operations described above are implemented by the CPU 31 executing these programs.

The following description is based on an aspect in which low-side three-phase dynamic braking is used as three-phase dynamic braking and low-side two-phase dynamic braking is used as two-phase dynamic braking.

### (2-1-5-1) Main Process

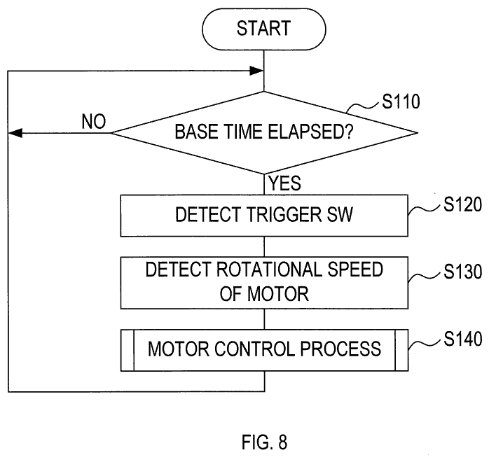

After activation, the control circuit 26 executes the main process shown in FIG. 8. When the main process is started, in S110, the control circuit 26 determines whether a base time has elapsed. The base time corresponds to the control period. That is, in S110, it is determined whether the control period has elapsed since it was determined that the base time has elapsed immediately preceding.

When the base time has elapsed, in S120, the control circuit 26 detects the state of the trigger switch 10 (whether the trigger switch 10 is on) based on the trigger signal. In S120, the amount of movement of the trigger switch 10 may be detected.

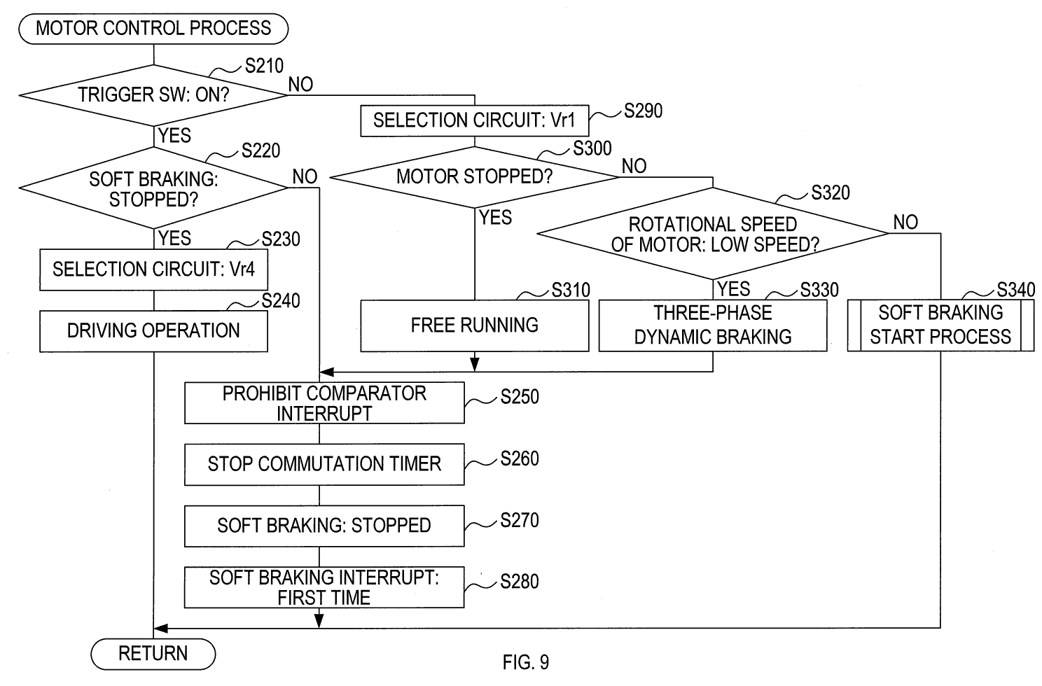

In S130, the control circuit 26 detects the rotational speed of the motor 20 based on the first, second, and third comparison information.
In S140, the control circuit 26 executes a motor control process. Details of the motor control process are as shown in FIG. 9.

As shown in FIG. 9, when the process proceeds to the motor control process, in S210, the control circuit 26 determines whether the trigger switch 10 is on. When the trigger switch 10 is on, the present process proceeds to S220.

In S220, the control circuit 26 determines whether a soft braking flag is set to “stopped”. The soft braking flag indicates whether soft braking is being performed. The soft braking means two-phase dynamic braking. Therefore, the “soft braking” may be read as “two-phase dynamic braking”.

When the soft braking flag is set to “stopped”, the present process proceeds to S230. In S230, the control circuit 26 causes the fourth reference voltage Vr4 to be set as the reference voltage in the selection circuit 36 by a switching signal to the selection circuit 36.

In S240, the control circuit 26 executes the driving operation. That is, the drive circuit 24 is controlled based on various information such as the amount of movement of the trigger switch 10, the electric angle of the motor 20 based on the first, second, and third comparison information, and the motor current value acquired in S120, thereby rotating the motor 20. After the process of S240, the present process proceeds to S110 (cf. FIG. 8).

When the soft braking flag is not set to “stopped” in S220, the present process proceeds to S250. In S250, the control circuit 26 prohibits a comparator interrupt. While a comparator interrupt is prohibited, a comparator interrupt process, which will be described later, is not executed even when a comparator edge occurs. That is, the comparator edge is ignored.

In S260, the control circuit 26 stops the commutation timer and resets the value of the commutation timer to an initial value (e.g., zero). The commutation timer is used to measure the delay time described above.
In S270, the control circuit 26 sets the soft braking flag to “stopped”.

In S280, the control circuit 26 sets a soft braking interrupt flag to “first time”. After the process of S280, the present process proceeds to S110 (cf. FIG. 8).
When the trigger switch 10 is turned off in S210, the present process proceeds to S290. In S290, the control circuit 26 causes the first reference voltage Vr1 (i.e., the voltage of the virtual neutral point) to be set as the reference voltage in the selection circuit 36 by the switching signal to the selection circuit 36.

In S300, the control circuit 26 determines whether the motor 20 is stopped. When the motor 20 is stopped, the present process proceeds to S310. In S310, the control circuit 26 executes free running. That is, all of the first to sixth switches Q1 to Q6 are turned off. After the execution of S310, the present process proceeds to S250.

When the motor 20 is rotating in S300, the control circuit 26 determines in S320 whether the rotational speed of the motor 20 is low. Here, the rotational speed detected in the immediately preceding S130 is set as the determination target. The low speed here means that the motor 20 is rotating at or below the predetermined rotational speed described above. When the rotational speed of the motor 20 is low, the present process proceeds to S330.

In S330, the control circuit 26 performs three-phase dynamic braking (here, specifically, low-side three-phase dynamic braking). That is, two-phase dynamic braking is performed during rotation at a rotational speed higher than the predetermined rotational speed, and the braking force is increased by three-phase dynamic braking during low-speed rotation at or below the predetermined rotational speed. Specifically, in S330, the three low-side switches are turned on, and the three high-side switches are turned off. After the process of S330, the present process proceeds to S250. In S330, high-side three-phase dynamic braking may be performed.

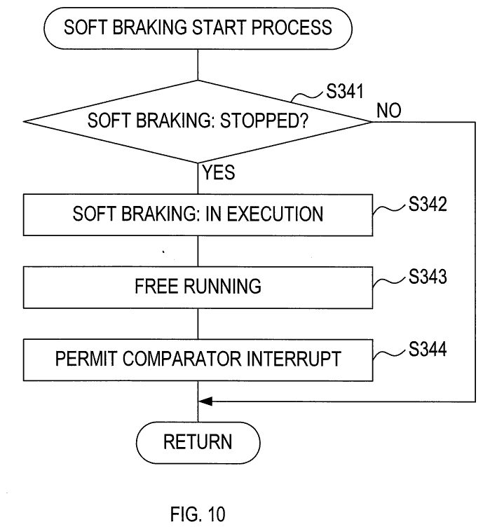

When the rotational speed of the motor 20 is not low in S320, the present process proceeds to S340. In S340, the control circuit 26 executes a soft braking start process. That is, two-phase dynamic braking (here, specifically, low-side two-phase dynamic braking) is started. Details of the soft braking start process are as shown in FIG. 10.

When the process proceeds to the soft braking start process, in S341, the control circuit 26 determines whether the soft braking flag is “stopped”. When the soft braking flag is not “stopped”, the present process proceeds to S110. When the soft braking flag is “stopped”, the present process proceeds to S342.

In S342, the control circuit 26 sets the soft braking flag to “in execution”.
In S343, the control circuit 26 executes free running similarly to S310. That is, two-phase dynamic braking is not executed immediately, but free running is executed first.

In S344, the control circuit 26 sets the comparator interrupt to “permitted”. After the execution of S344, the present process proceeds to S110.
FIG. 7 shows an example in which the trigger-off is performed at 360° in a state where the rotational speed of the motor 20 is not low. Thus, the soft braking start process of FIG. 10 is performed at 360°, whereby free running is executed and a comparator interrupt is permitted.

### (2-1-5-2) Comparator Interrupt Process

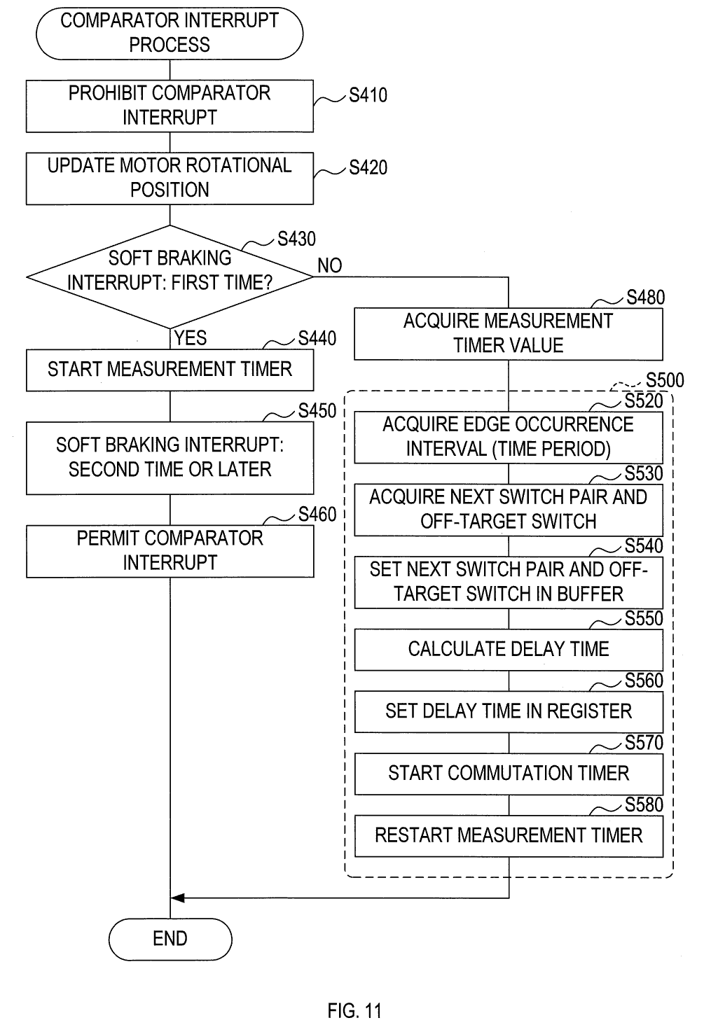

As described above, when the soft braking start process of FIG. 10 is performed, a comparator interrupt is permitted. While a comparator interrupt is permitted, the control circuit 26 executes the comparator interrupt process of FIG. 11 each time a comparator edge occurs. For example, in FIG. 7, the comparator interrupt process of FIG. 11 is executed when a comparator edge of 420°, 480°, 600°, 720°, 840°, or the like occurs.

When a comparator interrupt is started, in S410, the control circuit 26 sets the comparator interrupt to “temporarily prohibited”.
In S420, the control circuit 26 updates the rotational position of the motor 20 based on the first, second, and third comparison information at the present time. That is, the latest rotational position at the present time is acquired.

In S430, the control circuit 26 determines whether the soft braking interrupt flag is set to “first time”. When the soft braking interrupt flag is set to “first time”, the present process proceeds to S440. While the motor is stopped, the soft braking interrupt flag is set to “first time” in S280. Then, the flag setting is maintained even after the start of the driving operation. Thus, in the first comparator interrupt process after trigger-off, a soft braking interrupt flag is set to “first time”. Therefore, in this case, the present process proceeds to S440.

In S440, the control circuit 26 starts clocking with the measurement timer.
In S450, the control circuit 26 sets the soft braking interrupt flag to “second time or later”. Thus, a negative determination is made in the subsequent process of S430.

In S460, the comparator interrupt is set to “permitted”. After the process of S460, the present comparator interrupt process is terminated.
When the soft braking interrupt flag is not set to “first time” in S430, the present process proceeds to S480. In S480, the control circuit 26 acquires the timer value of the measurement timer (i.e., the elapsed time from the start of the measurement timer). The timer value acquired here corresponds to the edge occurrence interval described above.

In S500, the control circuit 26 executes a timer process. The timer process includes the processes of S520 to S580. In S520, the control circuit 26 acquires the edge occurrence interval based on the timer value acquired in S480. As described above, the timer value acquired in S480 is substantially equal to the edge occurrence interval. Thus, the timer value may be acquired as the edge occurrence interval.

In S530, the control circuit 26 acquires a switch pair to be turned on and an off-target switch in the next switching operation. Specifically, based on the rotational position (electric angle) acquired in S420, the control circuit 26 acquires an electric angle (hereinafter referred to as a “next switching angle”) at which the next switching operation is performed. In the present embodiment, as described above, the delay angle is 90°. Thus, the electric angle obtained by adding 90° to the electric angle acquired in S420 is acquired as the next switching angle. Then, the control circuit 26 refers to the switch pair table of FIG. 5 to acquire a switch pair and an off-target switch corresponding to the next switching angle. For example, when the motor 20 rotates forward and the rotational position at the present time is 600°, the next switching angle is 690°. Therefore, in this case, the fifth and sixth switches Q5, Q6 are acquired as the switch pair, and the fourth switch Q4 is acquired as the off-target switch.

In S540, the control circuit 26 sets the next switch pair and off-target switch acquired in S530 (specifically, information indicating these) in a buffer.
In S550, the control circuit 26 calculates a delay time. Specifically, a delay time is calculated from the edge occurrence interval acquired in S520 and a predetermined delay angle (90° in the present embodiment) according to the estimation method described above.

In S560, the control circuit 26 sets the delay time calculated in S550 in a register.
In S570, the control circuit 26 starts the commutation timer. As described above, the commutation timer is used to cause a commutation timer interrupt (and thus perform the switching operation) after the lapse of the delay time.

In S580, the control circuit 26 restarts the measurement timer from the initial value. After the termination of the process of S580 (i.e., after the termination of the timer process of S500), the control circuit 26 terminates the comparator interrupt process.

As described above, it is not essential to provide the delay time. Thus, when the next switch pair and off-target switch are acquired in S530, the switching operation may be executed immediately.

### (2-1-5-3) Commutation Timer Interrupt Process

When the timer value of the commutation timer started in S570 of FIG. 11 reaches the delay time, a commutation timer interrupt occurs. When the commutation timer interrupt occurs, the control circuit 26 executes the commutation timer interrupt process shown in FIG. 12.

In S610, the control circuit 26 executes the switching operation based on the information on the next switch pair and off-target switch set in the buffer. That is, the set switch pair is turned on, and the off-target switch is turned off.

This switching operation leads to occurrence of a comparator edge (e.g., a comparator edge at 690°, 810°, 930°, or the like in FIG. 7). However, at the point when the switching operation of S610 is performed, the comparator interrupt is set to “prohibited”. Thus, the comparator edge caused by the switching operation is ignored.

After the switching operation is executed, the control circuit 26 sets the comparator interrupt to “permitted”in S620.

### 2-2. Second Embodiment

Another example of the motor control process will be described as a second embodiment. In the motor control process of the present second embodiment, the reference voltage used during the braking operation differs from that of the first embodiment. In the present second embodiment, similarly to the first embodiment, the main process (FIG. 8), the soft braking start process (FIG. 10), the comparator interrupt process (FIG. 11), and the commutation timer interrupt process (FIG. 12) are executed. However, the motor control process differs from that shown in FIG. 9 of the first embodiment.

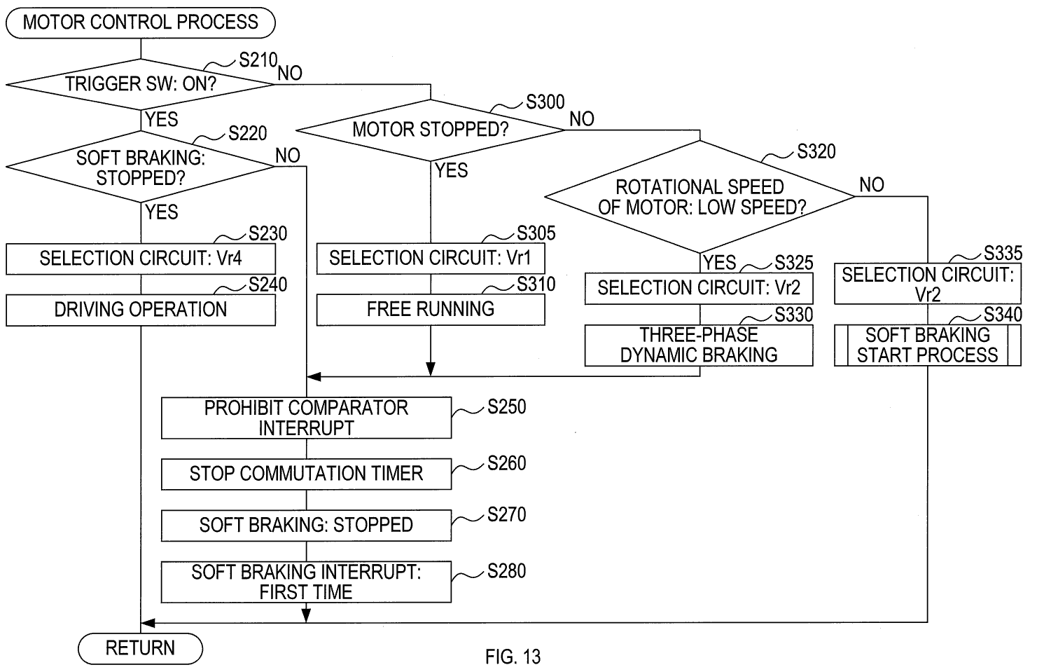

In the motor control process of the first embodiment, the first reference voltage Vr1 (i.e., the voltage of the virtual neutral point) has been used as the reference voltage during the braking operation.
In contrast, in the motor control process of the present second embodiment shown in FIG. 13, the second reference voltage Vr2 (i.e., the potential on the power source negative electrode side in the drive circuit 24) is used as the reference voltage during low-side three-phase dynamic braking and low-side two-phase dynamic braking. FIG. 13 shows the motor control process on the assumption that low-side three-phase dynamic braking and low-side two-phase dynamic braking are performed during dynamic braking.

In FIG. 13, the same processes as those in the motor control process of FIG. 9 of the first embodiment are denoted by the same reference numerals as those in FIG. 9. Hereinafter, only portions different from those in FIG. 9 will be described.
In the motor control process of the present second embodiment, when the trigger switch 10 is turned off in S210, the present process proceeds to S300 . When it is determined that the motor 20 is stopped in S300, the present process proceeds to S305.

In S305, the control circuit 26 causes the first reference voltage Vr1 (i.e., the voltage of the virtual neutral point) to be set as the reference voltage in the selection circuit 36 by the switching signal to the selection circuit 36. Then, the control circuit 26 executes free running in S310. That is, for free running, the first reference voltage Vr1 is used as the reference voltage as in the first embodiment.

On the other hand, when the rotational speed of the motor 20 is low in S320, the present process proceeds to S325. In S325, the control circuit 26 causes the second reference voltage Vr2 to be set as the reference voltage in the selection circuit 36. Then, the control circuit 26 executes low-side three-phase dynamic braking in S330.

When the rotational speed of the motor 20 is not low in S320, the present process proceeds to S335. In S335, as in S325, the control circuit 26 causes the second reference voltage Vr2 to be set as the reference voltage in the selection circuit 36. Then, the control circuit 26 executes the soft braking start process (cf. FIG. 10) in S330.

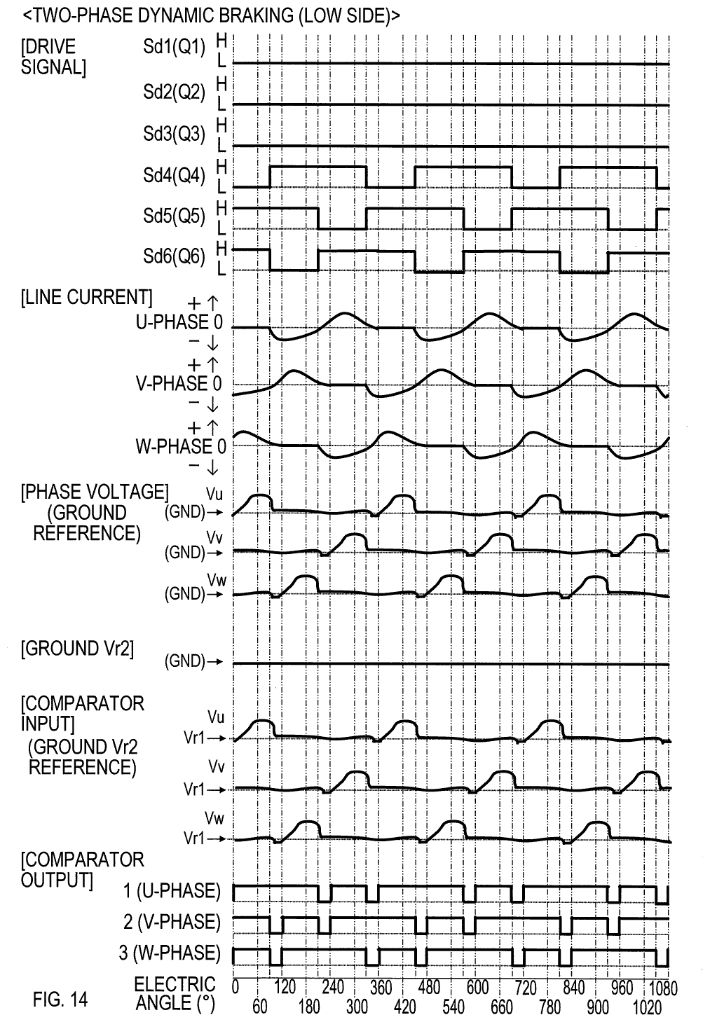

FIG. 14 shows an operation example of the motor 20 when two-phase dynamic braking is performed based on the motor control process of FIG. 13. FIG. 14 shows an operation example during forward rotation. In FIG. 14, “Ground Vr2” means the second reference voltage Vr2, that is, the reference voltage in the present second embodiment. In addition, “Comparator input” indicates the first, second, and third voltages Vu, Vv, Vw with reference to the second reference voltage Vr2 (i.e., the potential of ground or substantially ground).

As shown in FIG. 14, since the second reference voltage Vr2 is used as the reference voltage, the inputs and outputs of the first to third comparators 41 to 43 differ from those of the first embodiment. However, the switching operation is performed in the same manner as in the first embodiment.

For example, at 360°, a comparator edge occurs, and the comparator interrupt process (FIG. 11) is executed.
At this time, the switch pair is the fifth and sixth switches Q5, Q6, and the off-target switch is the sixth switch Q6. Although the switching operation may be performed at the timing of 360°, the delay time is also set in the present second embodiment. Then, at the timing (at or near 450°) when the delay time has elapsed, the commutation timer interrupt process (FIG. 12) is executed, and the switching operation is performed. Specifically, the switch pair is switched to the fourth and fifth switches Q4, Q5, and the sixth switch Q6 is turned off. At this time, the brake current flowing through the sixth switch Q6 is flowing in the specific direction and is also close to zero or substantially zero. Thus, in addition to preventing or suppressing the occurrence of regeneration, the electric current flowing through the sixth body diode D6 is also suppressed. Thereafter, a similar process is performed each time a comparator edge occurs, and as a result, the fourth to sixth switches Q4 to Q6 are switched in the same manner as in two-phase dynamic braking of the first embodiment.

When high-side three-phase dynamic braking and high-side two-phase dynamic braking are configured to be performed in the dynamic braking, the third reference voltage Vr3 is set as the reference voltage in the selection circuit 36 in S325 and S335.

### 2-3. Third Embodiment

In the motor control process (FIG. 9) of the first embodiment, when the trigger switch 10 is turned on (i.e., retriggered) during execution of two-phase dynamic braking (i.e., during deceleration of the motor 20), the braking operation is almost immediately stopped and the driving operation is started.

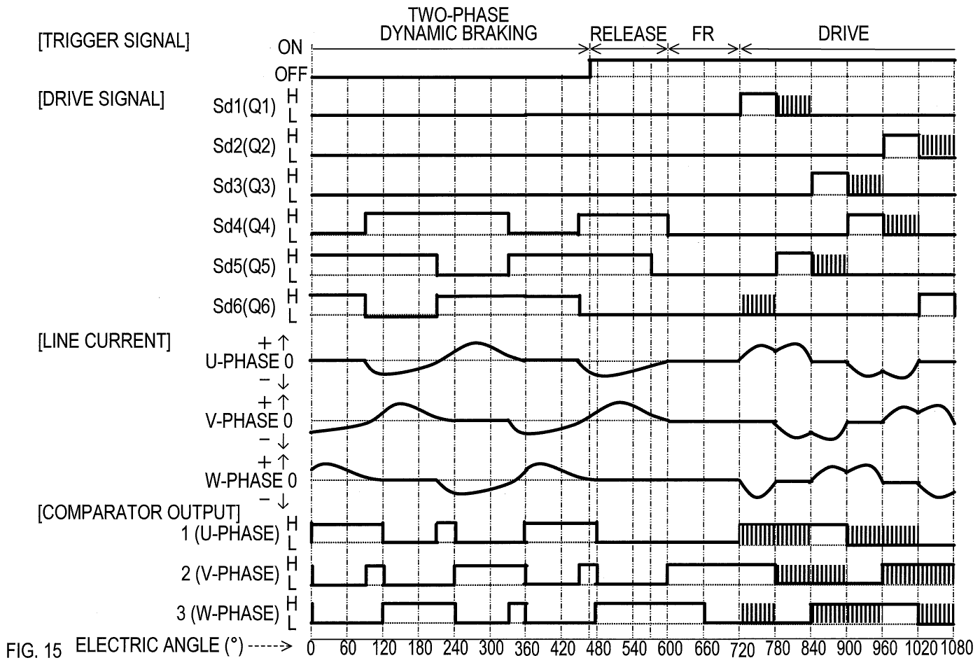

In contrast, in the present third embodiment, when retriggering is performed during the deceleration of the motor 20, the braking force is gradually weakened to make a shift to the driving operation. Specifically, as illustrated in FIG. 15, two-phase dynamic braking is shifted to one-phase dynamic braking, and then free running is further executed to make a shift to the driving operation. As described above, when retriggering is performed, the driving operation is started after the rotational speed of the motor 20 is gradually reduced, so that the behavior of the motor 20 is stabilized and the user's feeling of use is improved. Details will be described below.

### (2-3-1) Operation Example

An operation example of the motor 20 of the present third embodiment will be described with reference to FIG. 15. FIG. 15 illustrates an operation in which retriggering is executed during forward rotation and during execution of two-phase dynamic braking, whereby the driving operation is started. FIG. 15 shows an example in which low-side two-phase dynamic braking and low-side one-phase dynamic braking are performed in the braking operation.

In the example of FIG. 15, low-side two-phase dynamic braking is executed up to near 470°, and the motor 20 is decelerating. Then, near 470°, retriggering is performed, that is, the trigger switch 10 is turned on.

After the retriggering, a comparator edge occurs at 480°. At the first comparator edge after the retriggering, the delay time is set and the commutation timer starts. Then, switching is made to one-phase dynamic braking at the timing when the delay time has elapsed (at or near 570° in FIG. 15). That is, only one of the three low-side switches is turned on, and the other two and the three high-side switches are turned off. As a result, the motor 20 is braked with a braking force smaller than that of two-phase dynamic braking. In one-phase dynamic braking, one of the three high-side switches may be turned on.

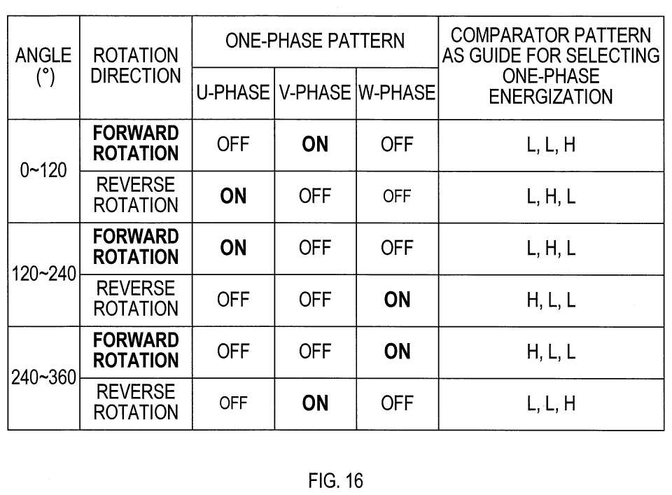

One switch to be turned on in one-phase dynamic braking is determined based on the electric angle of the motor 20 with reference to a one-phase pattern table illustrated in FIG. 16. As shown in FIG. 16, the switch pair in one-phase dynamic braking differs depending on whether the electric angle is greater than or equal to 0° and less than 120°, greater than or equal to 120° and less than 240°, and greater than or equal to 240° and less than 360°. Referring to FIG. 16, during forward rotation and at 570°, the U-phase switch, that is, the fourth switch Q4, is set as an on-target switch (cf. 210°). Thus, as shown in FIG. 15, at 570°, the fifth switch Q5 is turned off, and only the fourth switch Q1 is kept on.

When one-phase dynamic braking starts, the commutation timer starts again. Then, switching is made to free running at the timing when the set time has elapsed (at or near 600°in FIG. 15). After the free running, the driving operation is started.

### (2-3-2) Various Processes by Control Circuit

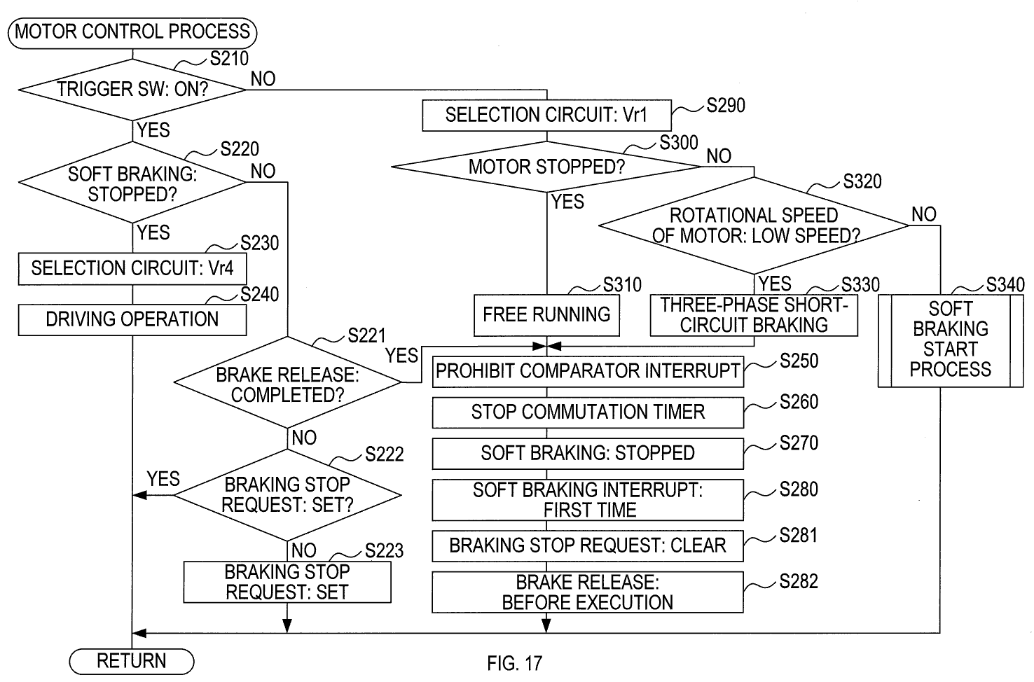

The motor control process, the comparator interrupt process, and the commutation timer interrupt process executed by the control circuit 26 to implement the operations described above will be described with reference to FIGS. 17 to 19. In the present third embodiment, similarly to the first embodiment, the main process (FIG. 8) and the soft braking start process (FIG. 10) are executed. However, the motor control process, the comparator interrupt process, and the commutation timer interrupt process differ from those of the first embodiment.

### (2-3-2-1) Motor Control Process

The motor control process of the present third embodiment will be described with reference to FIG. 17. In the motor control process of FIG. 17, the same processes as those in the motor control process of FIG. 9 of the first embodiment are denoted by the same reference numerals as those in FIG. 9. Hereinafter, only portions different from those in FIG. 9 will be described.

In the motor control process of the present third embodiment, when the soft braking flag is not set to “stopped” in S220, the process proceeds to S221.
In S221, the control circuit 26 determines whether a brake release flag is set to “completed”. The brake release flag is set to “completed” in response to the end of the one-phase dynamic braking described above and the shift to free running (cf. S770).

When the brake release flag is set to “completed”, the process proceeds to S250 because the braking operation has substantially ended and a smooth shift to the driving operation is possible. Thus, the soft braking flag is set to “stopped” (S270). As a result, an affirmative determination is made in the next process of S220, and the driving operation is performed in S240.

After the process of S280, the control circuit 26 clears a braking stop request flag in S281. The braking stop request flag is set in S223. The fact that the braking stop request flag is set indicates that the braking operation is currently being executed and the braking operation is to be stopped.

In S282, the control circuit 26 sets the brake release flag to “before execution”.
On the other hand, when the brake release flag is not set to “completed” in S221, two-phase dynamic braking or one-phase dynamic braking is still being executed. Therefore, in this case, the present process proceeds to S222.

In S222, the control circuit 26 determines whether a braking stop request flag is set. When the braking stop request flag is set, the present motor control process is terminated. When the braking stop request flag has not been set, the control circuit 26 sets the braking stop request flag in S223. After the process of S223, the control circuit 26 terminates the present motor control process.

### (2-3-2-2) Comparator Interrupt Process

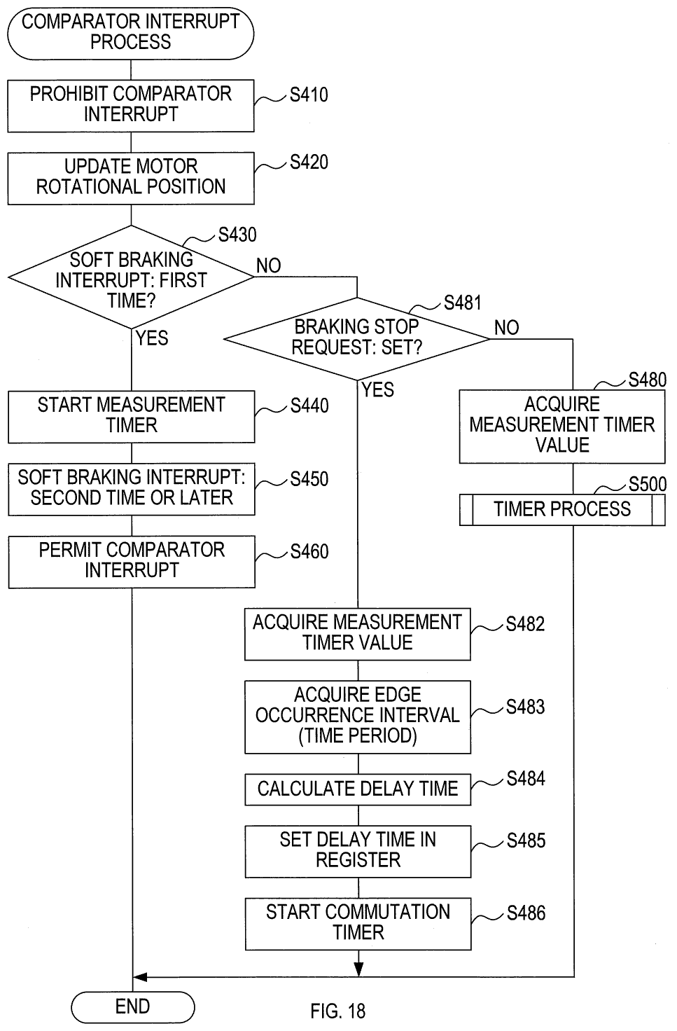

The comparator interrupt process of the present third embodiment will be described with reference to FIG. 18. In the comparator interrupt process of FIG. 18, the same processes as those in the comparator interrupt process of FIG. 11 of the first embodiment are denoted by the same reference numerals as those in FIG. 11. Hereinafter, only portions different from those in FIG. 11 will be described.

When the soft braking interrupt flag is not set to “first time” in S430, the present process proceeds to S481. In S481, the control circuit 26 determines whether a braking stop request flag is set. When the braking stop request flag is not set, the present process proceeds to S480.

When the braking stop request flag is set, the present process proceeds to S482. In S482, the control circuit 26 acquires the timer value of the measurement timer as in S480. The timer value acquired here corresponds to the edge occurrence interval described above.

In S483, the control circuit 26 acquires the edge occurrence interval based on the timer value acquired in S482 in the same manner as in S520.
In S484, the control circuit 26 calculates a delay time. Specifically, the delay time is calculated from the edge occurrence interval acquired in S483 and a predetermined delay angle (90° in the present embodiment) according to the estimation method described above.

In S485, the control circuit 26 sets the delay time calculated in S484 in the register.
In S486, the control circuit 26 starts the commutation timer.

### (2-3-2-3) Commutation Timer Interrupt Process

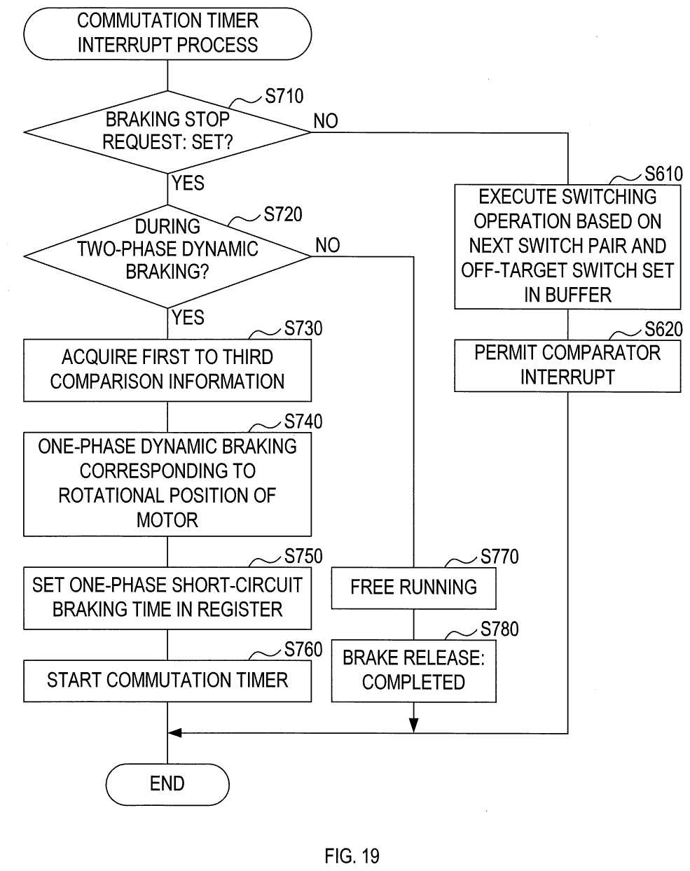

The commutation timer interrupt process of the present third embodiment will be described with reference to FIG. 19. In the commutation timer interrupt process of FIG. 19, the same processes as those in the commutation timer interrupt process of FIG. 12 of the first embodiment are denoted by the same reference numerals as those in FIG. 12. Hereinafter, only portions different from those in FIG. 12 will be described.

In S710, the control circuit 26 determines whether a braking stop request flag has been set. When the braking stop request flag is not set, the present process proceeds to S610. S610 and the subsequent steps are the same as in the first embodiment.

When the braking stop request flag is set, the present process proceeds to S720. In S720, the control circuit 26 determines whether two-phase dynamic braking is currently in execution. When two-phase dynamic braking is in execution, the present process proceeds to S730.

In S730, the control circuit 26 acquires the first, second, and third comparison information.

In S740, the control circuit 26 calculates the rotational position of the motor 20 based on the first, second, and third comparison information acquired in S730. Then, with reference to the one-phase pattern table (FIG. 16), the control circuit 26 turns on only one switch to be turned on at the rotational position at the present time, and turns off all the other switches. That is, one-phase dynamic braking is executed.

In S750, the control circuit 26 sets a one-phase dynamic braking time. The one-phase dynamic braking time is a time during which one-phase dynamic braking is to be executed. The one-phase dynamic braking time may be set in any manner. The one-phase dynamic braking time may be, for example, the same as the delay time set in the register in S485 of the latest comparator interrupt process.

In S760, the control circuit 26 starts the commutation timer. Thereby, the present commutation timer interrupt process is terminated.
After the commutation timer is started in S760, in response to the value of the commutation timer reaching the one-phase dynamic braking time set in S750, the commutation timer interrupt occurs again, and the commutation timer interrupt process in FIG. 19 is executed again. In this case, since one-phase dynamic braking is being performed, it is determined in S720 that two-phase dynamic braking is not in execution, and the process proceeds to S770.

In S770, the control circuit 26 executes free running.
In S780, the control circuit 26 sets the brake release flag to “completed”. As a result, in the next motor control process, the process proceeds from S221 to S250. Then, the soft braking flag is set to “stopped” (S270). Thus, in the next motor control process, an affirmative determination is made in S220, so that the driving operation (S240) is performed.

### 2-4. Fourth Embodiment

In the first, second, and third embodiments, when a comparator interrupt occurs, a comparator interrupt is temporarily prohibited (S410 in FIG. 11). Thus, after the commutation timer starts in S570, even when a comparator edge occurs, the comparator edge is ignored. That is, a comparator interrupt does not occur. This is to invalidate the comparator edge occurring through the switching operation when the delay time elapses.

However, since a comparator interrupt is temporarily prohibited in this way, when the delay time is not appropriately set, a comparator interrupt may not occur even when a comparator edge occurs. Specifically, if the delay time is set to be long, the delay time may still not elapse even when the next comparator edge occurs after the start of the commutation timer, which may cause the comparator edge to be unintentionally ignored. That is, a timer interrupt delay may not occur. The timer interrupt delay means that the commutation timer interrupt (i.e., the lapse of the delay time) occurs later than the occurrence timing of the next comparator edge.

The timer interrupt delay can occur due to various factors. For example, even when the delay time is appropriately set, a timer interrupt delay may occur due to the subsequent behavior of the motor 20, various characteristics of the motor 20, or the like.

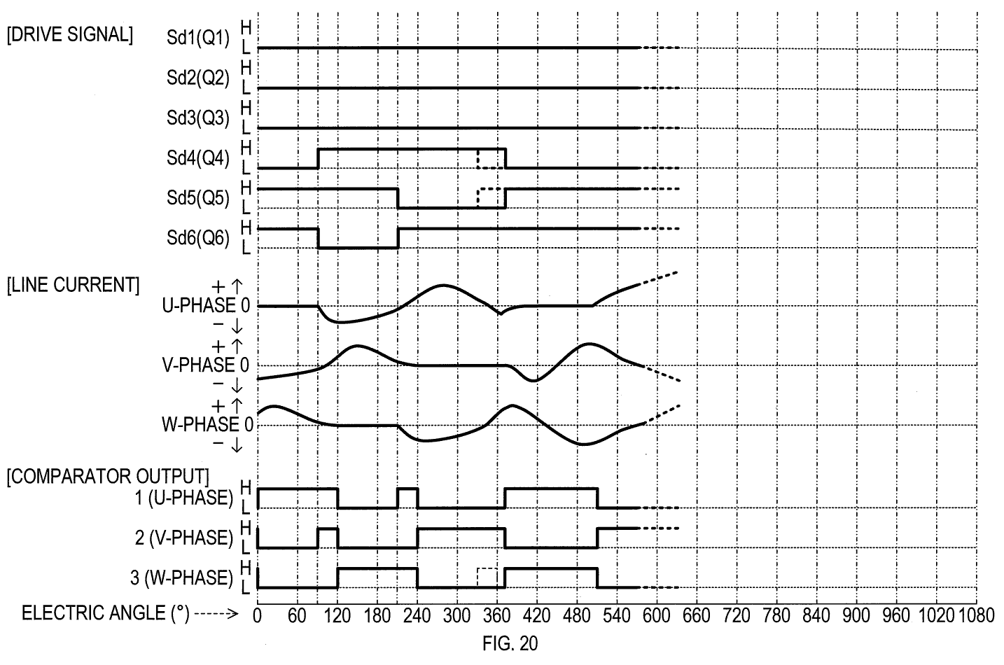

A specific example of the timer interrupt delay will be described with reference to FIG. 20. In FIG. 20, for example, a comparator edge occurs at 240°. Thus, a comparator interrupt is temporarily prohibited, the delay time is set, and the commutation timer starts. In this case, as indicated by a broken line in FIG. 20, originally, around 330° (or at least before 360°), the delay time is to elapse, a commutation timer interrupt is to occur, and the switching operation is to be performed.

However, in FIG. 20, after the occurrence of the timer interrupt delay, the delay time elapses and a commutation timer interrupt occurs near 370°. In this case, a comparator interrupt is prohibited between 240° and around 370°. Thus, even when a comparator edge occurs at 360°, the comparator edge is ignored. In the example of FIG. 20, since the switching operation that is to be originally performed near 330° is not performed, a comparator edge itself does not occur even when the angle reaches 360°. Thus, at 360°, the comparator interrupt that is to originally occur does not occur. Then, the next occurrence of the comparator interrupt is at 510°, and as a result, the switching operation is delayed, and the two-phase dynamic braking is not appropriately performed.

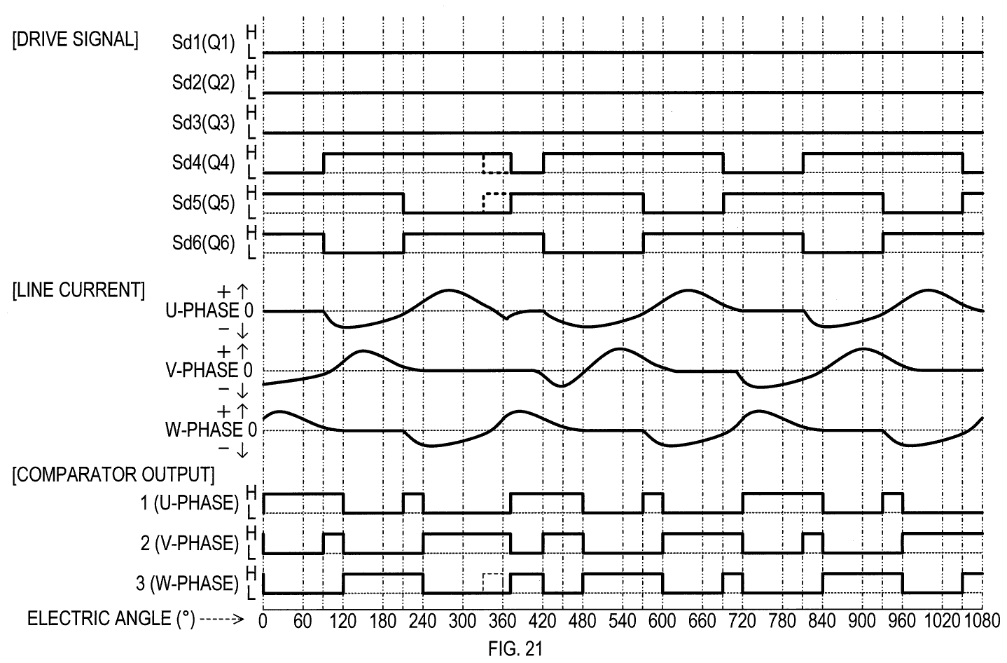

Therefore, in the present fourth embodiment, when a timer interrupt delay occurs, control is performed to cause the next comparator edge interrupt to occur as soon as possible.
A specific operation example will be described with reference to FIG. 21. In FIG. 21, the operation until the commutation timer interrupt occurs near 370° is the same as that in FIG. 20. That is, also in FIG. 21, a timer interrupt delay occurs, and the commutation timer interrupt that is to occur at 330° occurs at 370°.

In the present fourth embodiment, it is determined whether a timer interrupt delay occurs each time a commutation timer interrupt occurs. Specifically, each time a commutation timer interrupt occurs, the time measurement is started (specifically, the commutation timer is started as described later) by setting a determination time period corresponding to a determination angle. In this case, a commutation timer interrupt occurs when the determination time period elapses.

In the present fourth embodiment, the determination angle is larger than the electric angle (e.g., 30°) from the timing at which a commutation timer interrupt is to normally occur to the occurrence of the next comparator edge (e.g., 210° to 240°). An estimated value of the time required to rotate the determination angle is set as the determination time period.

Since the determination time period is set as described above, in a normal state, after a normal commutation timer interrupt occurs at 210°, a comparator edge occurs at 240° before the determination time period elapses (i.e., before the determination angle rotates).

On the other hand, when a timer interrupt delay has occurred, the determination time period elapses before the next comparator edge occurs. In FIG. 21, a timer interrupt delay has occurred at 370°. Thus, even when the determination time period elapses from 370°, a comparator edge does not occur. In other words, after 370°, the determination time period elapses before a comparator edge occurs. In FIG. 21, the determination time period elapses at 420°.

Therefore, in such a case, the switching operation is performed at the timing (420°) when the determination time period has elapsed. This is one of the most characteristic configurations of the present fourth embodiment. As a result, a comparator interrupt also occurs when the next comparator edge occurs at 480°. In contrast, in the example of FIG. 20, a comparator interrupt does not occur at 480°. Hence, in the present fourth embodiment, even when a timer interrupt delay occurs, the subsequent two-phase dynamic braking can be appropriately performed.

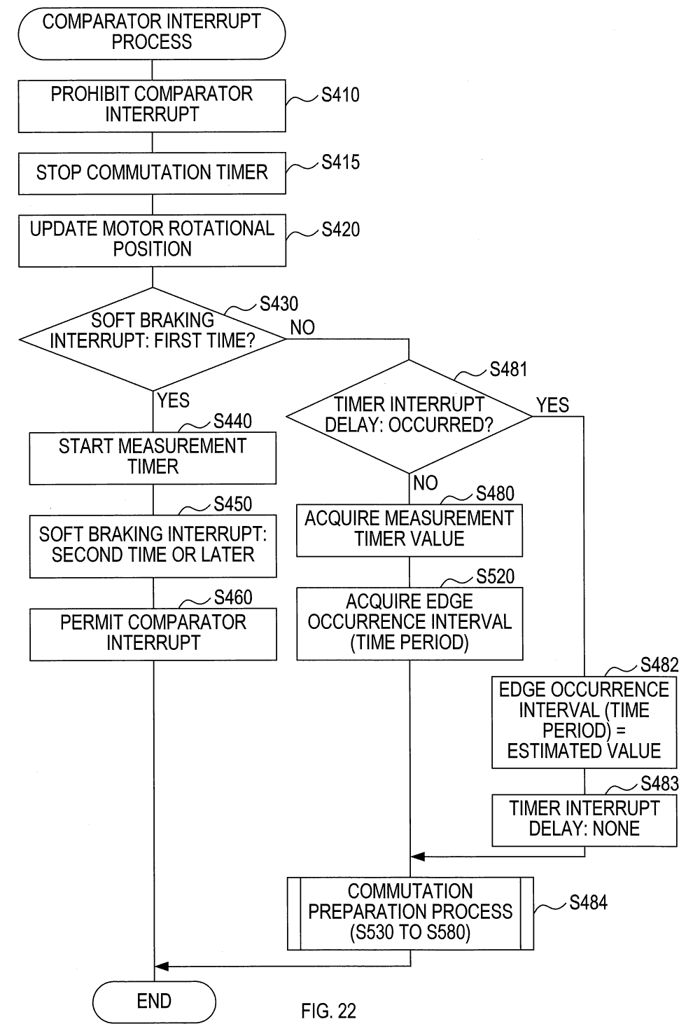

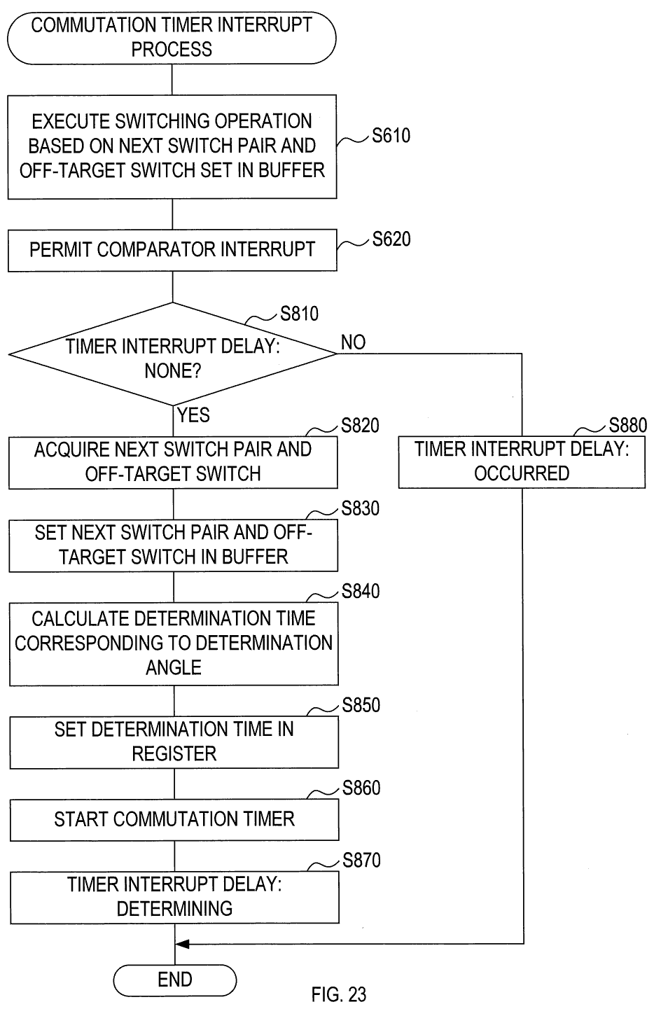

The comparator interrupt process and the commutation timer interrupt process of the present fourth embodiment executed to implement such an operation will be described with reference to FIGS. 22 and 23. In the present fourth embodiment, similarly to the first embodiment, the main process (FIG. 8) and the soft braking start process (FIG. 10) are executed.

### (2-4-1) Comparator Interrupt Process

The comparator interrupt process of the present fourth embodiment will be described with reference to FIG. 22. In the comparator interrupt process of FIG. 22, the same processes as those in the comparator interrupt process of FIG. 11 of the first embodiment are denoted by the same reference numerals as those in FIG. 11. Hereinafter, only portions different from those in FIG. 11 will be described.

In the comparator interrupt process of the present fourth embodiment, when the soft braking interrupt flag is not set to “first time” in S430, the present process proceeds to S481. In S481, the control circuit 26 determines whether a timer interrupt delay flag is set to “occurred”.

The timer interrupt delay flag is set to “occurred” in S880 in the commutation timer interrupt process of FIG. 23. The process of S880 is performed at the timing of 420° in the operation example of FIG. 21. That is, in the commutation timer interrupt process executed at 370°, the timer interrupt delay flag is set to “determining” by the process of S870. Normally, after the commutation timer interrupt process is executed, a comparator edge occurs and the comparator interrupt process is executed before the determination time period elapses. For example, in FIG. 21, a commutation timer interrupt occurs at 210°, and then a comparator interrupt occurs at 240°. However, when a timer interrupt delay has occurred, after a commutation timer interrupt occurs, the commutation timer interrupt occurs again after the determination time period elapses before a comparator edge occurs. In such a case, the timer interrupt delay flag is set to “occurred” in S880.

When the timer interrupt delay flag is not set to “occurred” in S481 , the present process proceeds to S480. In this case, no timer interrupt delay has occurred. Therefore, the control circuit 26 sequentially executes the processes of S480, S520, and S484. The processes of S480 and the subsequent steps are the same as the processes of S480 and the subsequent steps in FIG. 11. That is, the commutation preparation process of S484 is the processes of S530 to S580 in FIG. 11.

When the timer interrupt delay flag is set to “occurred” in S481, the present process proceeds to S482. In this case, a timer interrupt delay has occurred. Therefore, in S482, the control circuit 26 sets an estimated value as the edge occurrence interval.

The estimated value may be calculated in any manner. For example, the edge occurrence interval, acquired in the comparator interrupt process executed immediately preceding, may be calculated as the estimated value. Alternatively, the estimated value may be estimated (i.e., calculated) from the measurement timer value at the present time. For example, a value equal to one-half of the measurement timer value at the present time may be calculated as the estimated value. This is because the value of the measurement timer at the point of S482, when the timer interrupt delay has occurred, is basically the time required for the motor 20 to rotate by 240°.

For example, in the operation example of FIG. 21, the timing of 480° is the timing at which it is determined in S481 that the timer interrupt delay flag is set to “occurred”. The value of the measurement timer at 480° is the value of the measurement timer started at 240°. That is, in the example of FIG. 21, the measurement timer started at 240° is continued without being interrupted up to 480°. It can thus be estimated that one-half of the value of the measurement timer at the timing of 480° is the time required for the rotation from 360° to 480° immediately before, or a time very close thereto. It can be estimated that the edge occurrence interval acquired at 240°, which is the time when the comparator interrupt occurs immediately preceding, is the same as or very close to the time required for the rotation from 360° to 480° immediately before. Therefore, the edge occurrence interval acquired in the previously comparator interrupt process may be calculated as the estimated value.

After the process of S482, the control circuit 26 sets the timer interrupt delay flag to “none” in S483. After the execution of S483, the present process proceeds to S484. That is, the control circuit 26 executes S530 to S580 (cf. FIG. 11).

### (2-4-2) Commutation Timer Interrupt Process

The commutation timer interrupt process of the present fourth embodiment will be described with reference to FIG. 23. In the commutation timer interrupt process of FIG. 23, the same processes as those in the commutation timer interrupt process of FIG. 12 of the first embodiment are denoted by the same reference numerals as those in FIG. 12. Hereinafter, only portions different from those in FIG. 12 will be described.

In the commutation timer interrupt process of the present fourth embodiment, the process proceeds from S620 to S810. In S810, the control circuit 26 determines whether the timer interrupt delay flag is set to “none”. When the timer interrupt delay flag is set to “none”, the present process proceeds to S820.

In S820, the control circuit 26 acquires a switch pair to be turned on next and an off-target switch. For example, based on the rotational position at the present time, the control circuit 26 may refer to the switch pair table of FIG. 5 to acquire the next switch pair and off-target switch.

In S830, the control circuit 26 sets the next switch pair and off-target switch acquired in S820 (specifically, information indicating them) in the buffer.
In S840, the control circuit 26 calculates a determination time period corresponding to the determination angle. Specifically, the time required to rotate the determination angle (i.e., determination time period) is calculated from the time from the previously occurrence of the comparator interrupt to the present occurrence of the commutation timer interrupt, and the determination angle (30° in the present embodiment).

In S850, the control circuit 26 sets the delay time calculated in S840 in the register.
In S860, the control circuit 26 starts the commutation timer based on the determination time period. That is, the commutation timer is started so that the commutation timer interrupt occurs after the lapse of the determination time period.

In S870, the control circuit 26 sets the timer interrupt delay flag to “determining”.
When the timer interrupt delay flag is not set to “none” in S810, the present process proceeds to S880. In S880, the control circuit 26 sets the timer interrupt delay flag to “occurred”.

### 2-5. Fifth Embodiment

As described above, when two-phase dynamic braking is executed, the control circuit 26 may execute only high-side two-phase dynamic braking. In the present fifth embodiment, an operation example when high-side two-phase dynamic braking is executed in two-phase dynamic braking will be described. In high-side two-phase dynamic braking, the third reference voltage Vr3 is used as the reference voltage.

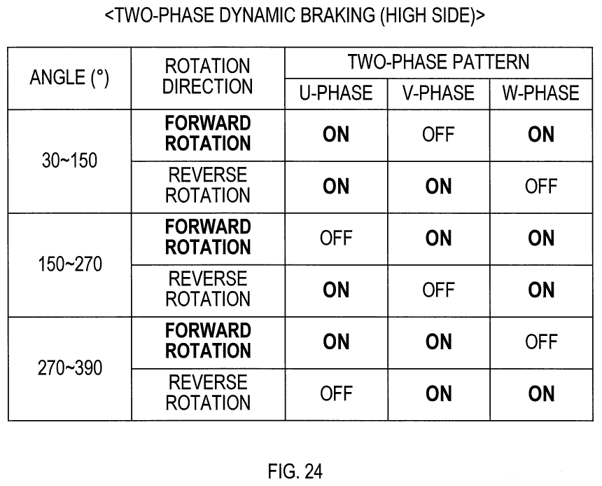

In high-side two-phase dynamic braking, a switch pair table as illustrated in FIG. 24 is prepared. As shown in FIG. 24, when high-side two-phase dynamic braking is performed, the switch pair differs depending on whether the electric angle is 30° or more and less than 150°, 150° or more and less than 270°, or 270° or more and less than 390°.

Each time a comparator edge occurs, the control circuit 26 refers to the switch pair table of FIG. 24 to acquire a switch pair and an off-target switch at the next switching angle, and sets the switch pair and the off-target switch in the buffer. When the commutation timer interrupt occurs, the control circuit 26 performs the switching operation according to the information set in the buffer.

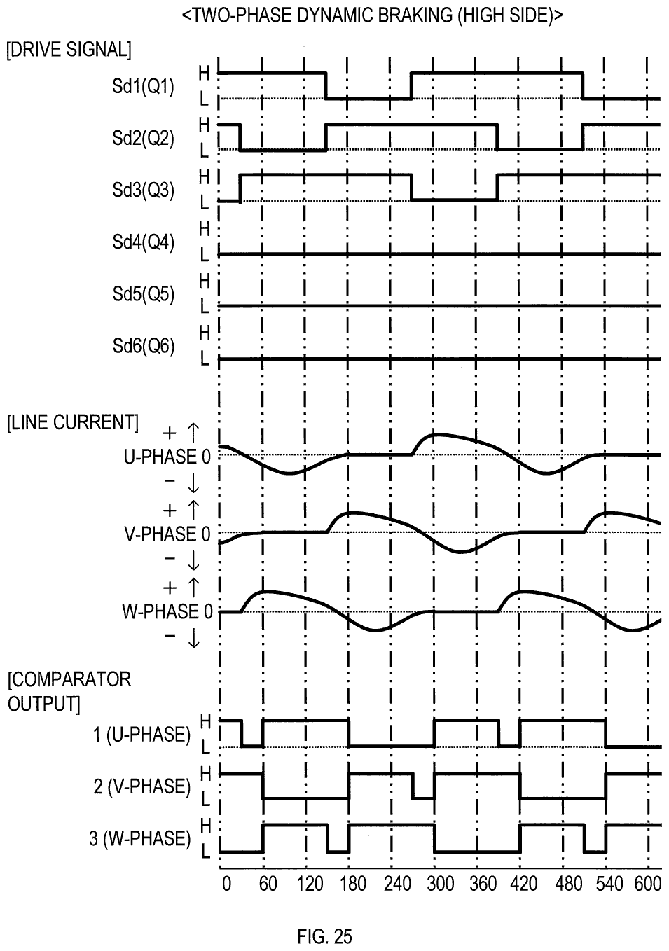

A specific operation example is shown in FIG. 25. FIG. 25 shows an operation example of high-side two-phase dynamic braking during forward rotation. As shown in FIG. 25, a comparator edge occurs at, for example, 180°. The switch pair that is on at this time is the second and third switches Q2, Q3. The next switching angle at the timing of 180°is 270°.

Therefore, the control circuit 26 refers to the switch pair table of FIG. 25 to acquire a switch pair to be switched at 270° and an off-target switch. At 270° in the forward rotation, the switch pair is the first switch Q1 (i.e., U-phase high-side switch) and the second switch Q2 (i.e., V-phase high-side switch), and the off-target switch is the third switch Q3 (i.e., W-phase high-side switch).

Thus, at 270° after the lapse of the delay time, the first switch Q1 is switched on and the third switch Q3 is switched off by the commutation timer interrupt. The second switch Q2 is maintained on.

### 2-6. Sixth Embodiment

As described above, when two-phase dynamic braking is executed, the control circuit 26 may selectively (e.g., alternately) execute high-side two-phase dynamic braking and low-side two-phase dynamic braking. In the sixth embodiment, an operation example when high-side two-phase dynamic braking and low-side phase dynamic braking are alternately executed in two-phase dynamic braking will be described.

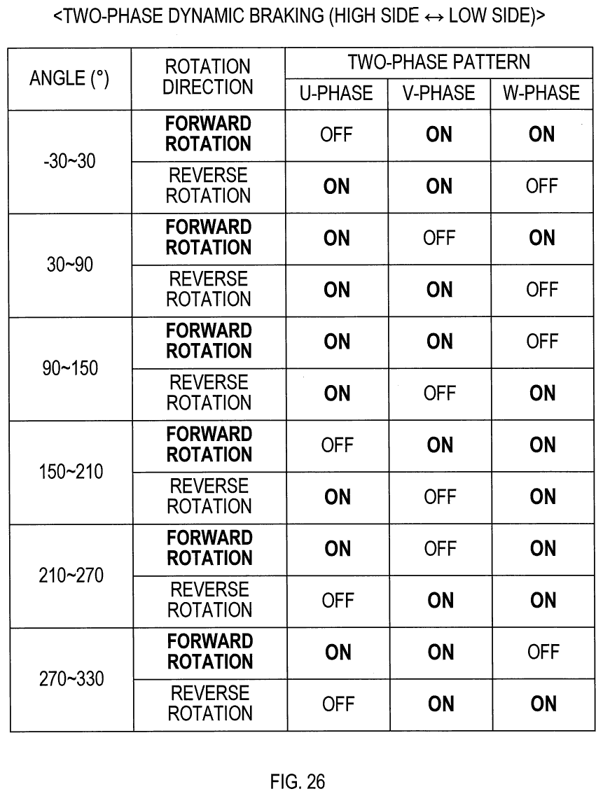

In the sixth embodiment, a switch pair table as illustrated in FIG. 26 is prepared. As shown in FIG. 26, when high-side two-phase dynamic braking and low-side two-phase dynamic braking are alternately performed, the switch pair differs depending on whether the electric angle is −30° or more and less than 30°, 30° or more and less than 90°, 90° or more and less than 150°, 150° or more and less than 210°, 210° or more and less than 270°, or 270° or more and less than 330°.

Each time a comparator edge occurs, the control circuit 26 refers to the switch pair table of FIG. 26 to acquire a switch pair and an off-target switch at the next switching angle, and sets the switch pair and the off-target switch in the buffer. When the commutation timer interrupt occurs, the control circuit 26 performs the switching operation according to the information set in the buffer.

At this time, when high-side two-phase dynamic braking is being performed, the control circuit 26 (i) switches two-phase dynamic braking to low-side two-phase dynamic braking, and (ii) switches the reference voltage to the second reference voltage Vr2. Conversely, when low-side two-phase dynamic braking has been performed when the comparator edge occurs, the control circuit 26 (i) switches two-phase dynamic braking to high-side two-phase dynamic braking, and (ii) switches the reference voltage to the third reference voltage Vr3.

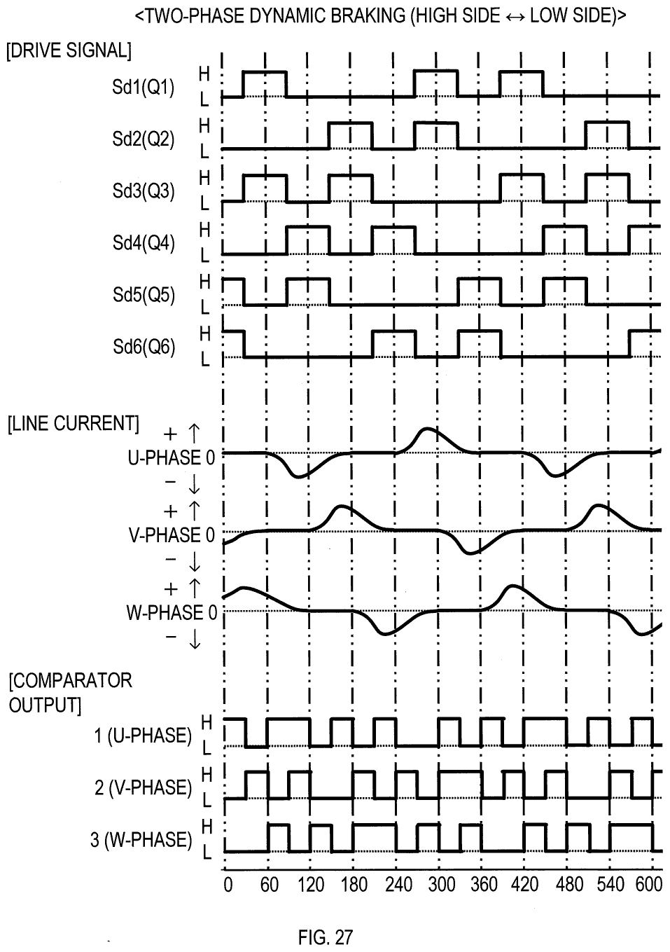

A specific operation example is shown in FIG. 27. FIG. 27 shows an operation example during forward rotation. As shown in FIG. 27, a comparator edge occurs at, for example, 120°. The switch pair that is on at this time is the fourth and fifth switches Q4, Q5. That is, low-side two-phase dynamic braking is being performed. Thus, in the next switching operation, switching is made to high-side two-phase dynamic braking.

In the sixth embodiment, the delay angle is set to, for example, 30°. Thus, the next switching angle at the timing of 120° is 150°.
Therefore, the control circuit 26 refers to the switch pair table in FIG. 26 to acquire the switch pair and the off-target switch in high-side two-phase dynamic braking at 150°. According to the switch pair table of FIG. 26, the V phase and the W-phase are set as the switch pair at 150° during forward rotation. Hence, the second switch Q2 (i.e., V-phase high-side switch) and the third switch Q3 (i.e., W-phase high-side switch) are acquired as the switch pair. The fourth switch Q4 and the fifth switch Q5 that are currently on are set as the off-target switches.

Thus, at 150° after the lapse of the delay time, the second and third switches Q2, Q3 are switched to on and the fourth and fifth switches Q4, Q5 are switched to off by the commutation timer interrupt. The comparator edge based on the commutation timer interrupt process at 150° is ignored, as in the above embodiments.

Thereafter, a comparator edge occurs at 180°. The switch pair that is on at this time is the second and third switches Q2, Q3. That is, high-side two-phase dynamic braking is being performed. Thus, in the next switching operation, two-phase dynamic braking is switched to low-side two-phase dynamic braking. Further, since the delay angle is, for example, 30°, the next switching angle at the timing of 180° is 210°.

Therefore, the control circuit 26 refers to the switch pair table of FIG. 26 to acquire the switch pair and the off-target switch in low-side two-phase dynamic braking at 210°. According to the switch pair table of FIG. 26, the U phase and the W-phase are set as the switch pair at 210° during forward rotation. Hence, the fourth switch Q4 (i.e., U-phase low-side switch) and the sixth switch Q6 (i.e., W-phase low-side switch) are acquired as the switch pair. The second and third switches Q2, Q3 that are currently on are set as the off-target switches.

Thus, the fourth and sixth switches Q4, Q6 are switched on, and the second and third switches Q2, Q3 are switched off at 210° after the lapse of the delay time.

### 2-7. Other Embodiments

Although the embodiments of the present disclosure have been described above, the present disclosure is not limited to the embodiments described above, and various modifications can be made.

(1) The first to third comparators 41 to 43 may be provided in the control circuit 26. That is, some or all of the first to third comparators 41 to 43 may be incorporated in the microcomputer in the control circuit 26.

In this case, some or all of the functions of the first to third comparators 41 to 43 may be implemented by software processing in the control circuit 26. For example, the control circuit 26 may include a plurality of analog-to-digital (A/D) conversion circuits that perform A/D conversion on each of the first, second, and third voltages Vu, Vv, Vw, and the reference voltage. Then, based on the output signals from the A/D conversion circuits, the CPU 31 may implement functions equivalent to those of the first to third comparators 41 to 43 by software processing.

(2) In the first embodiment, the first to fourth reference voltages Vr1 to Vr4 are input to the selection circuit 36. However, any number of reference voltages may be input to the selection circuit 36. For example, the second and third reference voltages Vr2, Vr3 may not be used as the reference voltage. In this case, the second and third reference voltages Vr2, Vr3 may not be input to the selection circuit 36. That is, only the reference voltage used for controlling the motor 20 may be input to the selection circuit 36.

It is not essential to provide the selection circuit 36. For example, a configuration is assumed in which the fourth reference voltage Vr4 is used as the reference voltage in the driving operation, and the first reference voltage Vr1 is used as the reference voltage in the braking operation and the switching operation. In this case, three comparators may be provided for the driving operation, and three comparators may be separately provided for the braking operation. In this case, the selection circuit 36 is unnecessary.

(3) In the braking operation, only the two-phase dynamic braking operation may be executed. Alternatively, two or more types of braking operations, including the two-phase dynamic braking operation, may be sequentially performed.

For example, in the first embodiment, the braking operation has been performed in the order of the free running, the two-phase dynamic braking operation, and the three-phase dynamic braking operation. However, in the first embodiment, for example, the free running may be omitted. For example, instead of the two-phase dynamic braking operation and the three-phase dynamic braking operation, at least two of the one-phase dynamic braking operation, the two-phase dynamic braking operation, and the three-phase dynamic braking operation (including the two-phase dynamic braking operation) may be executed. For example, the one-phase dynamic braking operation, the two-phase dynamic braking operation, and the three-phase dynamic braking operation may be executed in this order. For example, the one-phase dynamic braking operation and the two-phase dynamic braking operation may be executed in this order. When two or more types of braking operations are performed in order, any braking operations may be executed in any order. For example, contrary to the first embodiment, the three-phase dynamic braking operation may be executed first, followed by the two-phase dynamic braking operation.

(4) In the third embodiment, the operation example in the case of triggering during execution of the two-phase dynamic braking operation has been described (FIG. 15). However, retriggering is performed during the braking operation, a shift may be made to the driving operation through any process. For example, when retriggering is performed, the braking operation may be immediately stopped and the driving operation may be started. For example, when retriggering is performed, one or more of the free running, the three-phase dynamic braking operation, the two-phase dynamic braking operation, and the one-phase dynamic braking operation may be sequentially performed, followed by the driving operation. In this case, any number of types of braking operations may be performed, and the braking operations may be performed in any order. For example, when retriggering is performed during execution of the three-phase dynamic braking operation, the three-phase dynamic braking operation may be sequentially switched to the two-phase dynamic braking operation, the one-phase dynamic braking operation, and the free running. Alternatively, in the third embodiment, the two-phase dynamic braking operation may be shifted to the driving operation without passing through the one-phase dynamic braking operation and/or free running.

(5) A plurality of functions of one component in the above embodiment may be implemented by a plurality of components, or one function of one component may be implemented by a plurality of components. A plurality of functions of a plurality of components may be implemented by one component, or one function implemented by a plurality of components may be implemented by one component. A portion of the configuration of the above embodiment may be omitted. At least a portion of the configuration of the above embodiment may be added to, or replaced with, the configuration of another above embodiment

What is claimed is:

1. An electric work machine comprising:
a brushless motor including three terminals configured to receive an electric power;
a drive circuit configured to supply the electric power to the brushless motor,
the drive circuit including:
three positive-electrode-side paths that respectively electrically couple the three terminals to a positive electrode of a power source;
three negative-electrode-side paths that respectively electrically couple the three terminals to a negative electrode of the power source; and
six switches including three positive-electrode-side switches and three negative-electrode-side switches, the three positive-electrode-side switches being (i) provided on the three positive-electrode-side paths, respectively, and (ii) configured to individually complete or interrupt the three positive-electrode-side paths, respectively, the three negative-electrode-side switches being (i) provided on the three negative-electrode-side paths, respectively, and (ii) configured to individually complete or interrupt the three negative-electrode-side paths, respectively; and
a control circuit configured to execute:
a driving operation of controlling the drive circuit, based on a back-EMF of the brushless motor generated at each of the three terminals, to rotate the brushless motor;
a braking operation of turning on a switch pair of the six switches and turning off other switches of the six switches during rotation of the brushless motor to thereby decelerate and/or stop the brushless motor, the switch pair being two of the three positive-electrode-side switches or two of the three negative-electrode-side switches; and
a switching operation of switching the switch pair during execution of the braking operation, the switching operation including turning off an off-target switch based on an electric current flowing through the off-target switch satisfying an off-requirement, the off-target switch being one of the switches in the switch pair at a present time.

2. The electric work machine according to claim 1,
wherein the off-requirement is satisfied based on the electric current flowing through the off-target switch avoiding a specific state,
wherein the specific state includes (i) that the electric current is flowing in a direction opposite to a specific direction and (ii) that a magnitude of the electric current corresponds to an extreme value, and
wherein the specific direction is (i) a direction from the brushless motor to the positive electrode via the off-target switch when the off-target switch is one of the three positive-electrode-side switches, and (ii) a direction from the negative electrode to the brushless motor via the off-target switch when the off-target switch is one of the three negative-electrode-side switches.

3. The electric work machine according to claim 1,
wherein the off-requirement is satisfied based on the electric current flowing in the specific direction at the off-target switch.

4. The electric work machine according to claim 1, further comprising:
a current information acquisition circuit configured to acquire current information on an electric current flowing through each of two or more specific switches, the two or more specific switches being two or more of the six switches that can be the switch pair in the braking operation,
wherein the control circuit is configured to execute the switching operation based on the current information acquired by the current information acquisition circuit.

5. The electric work machine according to claim 4,
wherein the three terminals include a first terminal, a second terminal, and a third terminal, and
wherein the current information acquisition circuit includes:
a first comparator configured to (i) receive a first voltage and a reference voltage, and (ii) output first comparison information indicating whether a value of the first voltage is greater than or equal to a value of the reference voltage, the first voltage being a voltage of the first terminal,
a second comparator configured to (i) receive a second voltage and the reference voltage, and (ii) output second comparison information indicating whether a value of the second voltage is greater than or equal to the value of the reference voltage, the second voltage being a voltage of the second terminal, and
a third comparator configured to (i) receive a third voltage and the reference voltage, and (ii) output third comparison information indicating whether a value of the third voltage is greater than or equal to the value of the reference voltage, the third voltage being a voltage of the third terminal.

6. The electric work machine according to claim 5,
wherein the control circuit is configured to execute the driving operation based on the first comparison information, the second comparison information, and the third comparison information output from the current information acquisition circuit.

7. The electric work machine according to claim 5,
wherein the off-requirement is satisfied based on a change in the first comparison information, the second comparison information, and/or the third comparison information.

8. The electric work machine according to claim 5,
wherein, in a state where the braking operation, in which two of the three negative-electrode-side switches are set as the switch pair, is being executed, the off-requirement is satisfied based on a value of a voltage of a first specific terminal becoming smaller than the value of the reference voltage, and the first specific terminal is one of the three terminals that is electrically coupled to the off-target switch.

9. The electric work machine according to claim 8,
wherein in a state where the braking operation, in which two of the three negative-electrode-side switches are set as the switch pair, is being executed, the off-requirement is satisfied based on arrival of an off-available timing,
wherein the off-available timing is a timing at which (i) the value of the voltage of the first specific terminal becomes smaller than the value of the reference voltage, and (ii) a value of a voltage of a second specific terminal becomes greater than or equal to the value of the reference voltage, and
wherein the second specific terminal is (i) one of the three terminals and (ii) electrically coupled to one of the three negative-electrode-side switches other than the switch pair.

10. The electric work machine according to claim 9,
wherein, in a state where the braking operation, in which two of the three negative-electrode-side switches are set as the switch pair, is being executed, the off-requirement is satisfied based on elapse of a delay time from the off-available timing.

11. The electric work machine according to claim 10,
wherein the control circuit is configured to set the delay time such that the off-requirement is satisfied when a magnitude of the electric current flowing through the off-target switch tends to decrease or is zero.

12. The electric work machine according to claim 10,
wherein the control circuit is configured to set, in response to arrival of the off-available timing, the delay time based on a rotational speed of the brushless motor at the arrival of the off-available timing.

13. The electric work machine according to claim 12,
wherein the control circuit is configured to set the delay time such that the lower the rotational speed of rotations of the brushless motor at the arrival of the off-available timing, the longer the delay time.

14. The electric work machine according to claim 5, further comprising a reference voltage generation circuit that includes:
a first resistor having (i) a first end electrically coupled to the first terminal and (ii) a second end;
a second resistor having (i) a first end electrically coupled to the second terminal and (ii) a second end electrically coupled to the second end of the first resistor; and
a third resistor having (i) a first end electrically coupled to the third terminal and (ii) a second end electrically coupled to the second end of the first resistor and the second end of the second resistor,
wherein the reference voltage generation circuit is configured to output a first reference voltage, and the first reference voltage is a voltage of the second end of the first resistor, a voltage of the second end of the second resistor, or a voltage of the second end of the third resistor, and
wherein the current information acquisition circuit is configured to receive the first reference voltage as the reference voltage from the reference voltage generation circuit.

15. The electric work machine according to claim 5,
wherein each of the three negative-electrode-side switches includes a negative-electrode-side terminal electrically coupled to the negative electrode, and
wherein the current information acquisition circuit is configured to receive a negative-electrode-side voltage as the reference voltage in a state where the braking operation, in which two of the three negative-electrode-side switches are set as the switch pair, is being executed, and the negative-electrode-side voltage is a voltage of the negative-electrode-side terminal of one of the three negative-electrode-side switches.

16. The electric work machine according to claim 5,
wherein each of the three positive-electrode-side switches includes a positive-electrode-side terminal electrically coupled to the positive electrode, and
wherein the current information acquisition circuit is configured to receive a positive-electrode-side voltage as the reference voltage in a state where the braking operation, in which two of the three positive-electrode-side switches are set as the switch pair, is being executed, and the positive-electrode-side voltage is a voltage of the positive-electrode-side terminal of one of the three positive-electrode-side switches.

17. The electric work machine according to claim 14,
wherein each of the three positive-electrode-side switches includes a positive-electrode-side terminal electrically coupled to the positive electrode, and
wherein each of the three negative-electrode-side switches includes a negative-electrode-side terminal electrically coupled to the negative electrode,
the electric work machine further comprising a selection circuit configured to (i) receive at least two reference voltages and (ii) alternatively output, as the reference voltage, one of the at least two reference voltages received, in which the at least two reference voltages are at least two of the first reference voltage, a second reference voltage, and a third reference voltage, the second reference voltage is a voltage of the negative-electrode-side terminal of one of the three negative-electrode-side switches, and the third reference voltage is a voltage of the positive-electrode-side terminal of one of the three positive-electrode-side switches,
wherein the current information acquisition circuit is configured to receive the reference voltage output from the selection circuit.

18. The electric work machine according to claim 14,
wherein each of the three positive-electrode-side switches includes a positive-electrode-side terminal electrically coupled to the positive electrode, and
each of the three negative-electrode-side switches includes a negative-electrode-side terminal electrically coupled to the negative electrode,
the electric work machine further comprising:
a fourth resistor having (i) a first end electrically coupled to the positive electrode and (ii) a second end;
a fifth resistor having (i) a first end electrically coupled to the negative electrode and (ii) a second end electrically coupled to the second end of the fourth resistor; and
a selection circuit configured to (i) receive at least two reference voltages and (ii) alternatively output, as the reference voltage, one of the at least two reference voltages received, in which the at least two reference voltages are at least two of the first reference voltage, a second reference voltage, a third reference voltage, and a fourth reference voltage, the second reference voltage is a voltage of the negative-electrode-side terminal of one of the three negative-electrode-side switches, the third reference voltage is a voltage of the positive-electrode-side terminal of one of the three positive-electrode-side switches, and the fourth reference voltage is a voltage of the second end of the fourth resistor
wherein the current information acquisition circuit is configured to receive the reference voltage output from the selection circuit.

19. The electric work machine according to claim 18,
wherein the selection circuit is configured to (i) output the fourth reference voltage as the reference voltage when the driving operation is being performed by the control circuit, and (ii) output the first reference voltage, the second reference voltage, or the third reference voltage as the reference voltage when the switching operation is being performed by the control circuit.

20. The electric work machine according to claim 1,
wherein each of the three positive-electrode-side switches includes a first rectifier connected in parallel with the corresponding positive-electrode-side switch, and
wherein the first rectifier is configured to (i) allow flowing an electric current from the brushless motor to the positive electrode via the first rectifier, and (ii) suppress or prevent flowing an electric current from the positive electrode to the brushless motor via the first rectifier.

21. The electric work machine according to claim 1,
wherein each of the three negative-electrode-side switches includes a second rectifier connected in parallel with the corresponding negative-electrode-side switch, and
wherein the second rectifier is configured to (i) allow flowing an electric current from the negative electrode to the brushless motor via the second rectifier, and (ii) suppress or prevent flowing an electric current from the brushless motor to the negative electrode via the second rectifier.
